(19) United States
(12) Patent Application Publication
(10) Pub. No.: US 2024/0414685 A1
(43) Pub. Date: Dec. 12, 2024

(54) POSITIONING MEASUREMENT PROCEDURE UNDER RRC STATE TRANSITION

(71) Applicant: Telefonaktiebolaget LM Ericsson (publ), Stockholm (SE)

(72) Inventors: Muhammad Ali Kazmi, Sundbyberg (SE); Ritesh Shreevastav, Upplands Väsby (SE); Venkatarao Gonuguntla, Sundbybyberg (SE); Santhan Thangarasa, Vällingby (SE); Dominik Frank, Rosenheim (DE)

(21) Appl. No.: 18/702,567

(22) PCT Filed: Oct. 21, 2022
(86) PCT No.: PCT/SE2022/050953

§ 371 Date: Apr. 18, 2024

(30) Foreign Application Priority Data
Oct. 21, 2021 (IN) 202141047900

(51) Int. Cl. H04W 64/00; H04W 76/27

(52) U.S. Cl. CPC H04W 64/003; H04W 76/27

(57) ABSTRACT

Systems and methods for performing positioning measurements are provided. In some embodiments, a method performed by a User Equipment, UE, for performing positioning measurements includes one or more of: being configured to perform a positioning measurement in a first Radio Resource Control, RRC, state (RRC1); being triggered to transition from RRC1 to a second RRC state (RRC2); in response to the trigger, adapting the ongoing positioning measurement procedure based on one or more rules; performing the positioning measurement based on the adapted measurement procedure; and informing a network node about the results of the measurement adaptation. In this way, the positioning measurement performance is enhanced in different RRC states; the UE can perform positioning measurements even when RRC state transition occurs; the UE behavior is predictable and well defined; improved UE power consumption; the UE does not always have to restart the measurement.

### RELATED APPLICATIONS

This application claims the benefit of Indian patent application No. 202141047900, filed Oct. 21, 2021, the disclosure of which is hereby incorporated herein by reference in its entirety.

### TECHNICAL FIELD

The current disclosure relates to positioning.

### BACKGROUND

NR architecture (TS 38.300 v16.7.0) is illustrated in FIG. 1, where gNB and ng-eNB (or evolved eNB) denote NR BSs (one NR BS may correspond to one or more transmission/reception points, TRPs), and the lines between the nodes illustrate the corresponding interfaces.

Location management function (LMF) is the location node or positioning server in NR. There are also interactions between the location node and the gNB via the NR Positioning Protocol Annex (NRPPa) (not illustrated in FIG. 1) and between UE and the location server via LTE positioning protocol (LPP), which is also used in NR. The interactions between the gNB and the UE is supported via the Radio Resource Control (RRC) protocol.

### NR UE Positioning Measurements

The following NR positioning measurements performed by the UE are specified:
RSTD: It is reference signal time difference between the positioning node j and the reference positioning node i. It is measured on the DL PRS signals and always involve two cells (cell is interchangeably called as TRP).
PRS-RSRP: PRS reference signal received power (PRS-RSRP) is the linear average over the power contributions (in [W]) of the resource elements that carry DL PRS reference signals.
UE Rx-Tx time difference: It is defined as T_{UE-RX}-T_{UE-TX}
Where:
   T_{UE-RX} is the UE received timing of downlink subframe #i from a positioning node, defined by the first detected path in time. It is measured on PRS signals received from the gNB.
   T_{UE-TX} is the UE transmit timing of uplink subframe #j that is closest in time to the subframe #i received from the positioning node. It is measured on SRS signals transmitted by the UE.
   The UE Rx-Tx time difference is an example of bidirectional timing measurement. More generally it is referred to as Round Trip Time (RTT).

The UE can be configured to measure one or multiple type of positioning measurements on one or multiple cells.

### Reference Signals for NR RTT Positioning Measurements

### Positioning Reference Signals

Positioning reference signal (PRS) are periodically transmitted on a positioning frequency layer in PRS resources in the DL by the gNB. The information about the PRS resources is signaled to the UE by the positioning node via higher layers but may also be provided by base station e.g., via broadcast. Each positioning frequency layer comprises PRS resource sets, where each PRS resource set comprises one or more PRS resources. All the DL PRS resources within one PRS resource set are configured with the same periodicity. The PRS resource periodicity (Tₚₑᵣ^{PPRS}) comprises:
Tₚₑᵣ^{PRS}∈2^{μ}{4, 8, 16, 32, 64, 5, 10, 20, 40, 80, 160, 320, 640, 1280, 2560, 5120, 10240, 20480} slots, where μ=0, 1, 2, 3 for PRS SCS of 15, 30, 60 and 120 kHz respectively. Tₚₑᵣ^{PRS} μ·20480 is not supported for μ=0.

Each PRS resource can also be repeated within one PRS resource set and takes values Tᵣₑₚ^{PRS}∈{1, 2, 4, 6, 8, 16, 32}.

PRS are transmitted in consecutive number of symbols (L_{PRS}) within a slot: L_{PRS}∈{2, 4, 6, 12}. The following DL PRS RE patterns, with comb size K_{PRS} equal to number of symbols L_{PRS} are supported
Comb-2: Symbols {0, 1} have relative RE offsets {0, 1}
Comb-4: Symbols {0, 1, 2, 3} have relative RE offsets {0, 2, 1, 3}
Comb-6: Symbols {0, 1, 2, 3, 4, 5} have relative RE offsets {0, 3, 1, 4, 2, 5}
Comb-12: Symbols {0, 1, 2, 3, 4, 5, 6, 7, 8, 9, 10, 11} have relative RE offsets {0, 6, 3, 9, 1, 7, 4, 10, 2, 8, 5, 11}

Maximum PRS BW is 272 PRBs. Minimum PRS BW is 24 PRBs. The configured PRS BW is always a multiple of 4.

In general, PRS resource set may comprise parameters such as Subcarrier Spacing (SCS), PRS BW, PRS resource set periodicity and slot offset with respect to reference time (e.g., SFN #0, slot #0), PRS resource repetition factor (e.g., number of times PRS resource repeated in a PRS resource set), PRS symbols in PRS resource, PRS resource time gap (e.g., number of slots between successive repetitions), PRS muting pattern, etc.

### Sounding Reference Signals

For positioning timing measurements (e.g., UE Rx-Tx, gNB, Rx-Tx, UL RTOA etc.), the UE is configured with SRS for uplink transmission. The SRS comprising one or more SRS resource set and each SRS resource set comprising one or more SRS resources. Each SRS resource comprising one or more symbols carrying SRS with certain SRS bandwidth. There can be periodic SRS, aperiodic SRS, and semi-persistent SRS transmissions-any of them can also be used for positioning measurements. There are two options for SRS configuration for positioning: In one example the UE can be configured with SRS resource set where each SRS resource occupies N_{S}∈{1, 2, 4} adjacent symbols within a slot. In this case SRS antenna switching is supported. Each symbol can also be repeated with repetition factor R∈{1,2,4}, where R≤Ns. The periodic SRS resource can be configured with certain periodicity (T_{SRS}) e.g.:
T_{SRS}∈{1, 2, 4, 5, 8, 10, 16, 20, 32, 40, 64, 80, 160, 320, 640, 1280, 2560} slots.

In another example the UE can be configured with SRS positioning specific resource set (SRS-PosResourceSet). In this case each SRS positioning resource (SRS-PosResource) occupies N_{S}∈{1, 2, 4, 8, 12} adjacent symbols within a slot. In this case SRS antenna switching is not supported. In both options, the UE can be configured with 1, 2, or 4 antenna ports for transmitting each SRS resource within SRS resource set. The default value is one SRS antenna port for each SRS resource.

### Positioning Methods

The NR supports the following RAT dependent positioning methods:

DL-TDOA: The DL time of arrival (DL TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighbouring TPs.

Multi-RTT: The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

UL-TDOA: The UL Time Difference of Arrival (UL-TDOA) positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

DL-AoD: The DL Angle of Departure (DL AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.

UL-AoA: The UL angle of departure (UL AoA) positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

NR-ECID: NR Enhanced Cell ID (NR E-CID) positioning refers to techniques which use additional UE measurements and/or NR radio resource and other measurements to improve the UE location estimate.

### Measurement Gaps

In NR, a Measurement Gap Pattern (MGP) is used by the UE in RRC connected state for performing measurements on cells of one or more carriers. The positioning measurements are done on cells of the Positioning Frequency Layer (PFL). In NR the positioning measurements in RRC connected state are performed using MGP. The UE is scheduled in the serving cell only within the BWP. During the gap the UE cannot be scheduled for receiving/transmitting signals in the serving cell. A measurement gap pattern is characterized or defined by several parameters: Measurement Gap Length (MGL), Measurement Gap Repetition Period (MGRP), Measurement Gap Time Offset (MGTO) with respect to reference time (e.g., slot offset with respect to serving cell's SFN such as SFN=0), Measurement Gap Timing Advance (MGTA), etc. For example, a MGP can be configured with Measurement Gap Repetition periodicity (MGRP) (e.g., {20, 40, 80, 160} ms) and with MGL (e.g., {1.5, 3, 3.5, 4, 5.5, 6, 10, 20} ms). The UE may also be configured with multiple MGPs in parallel for performing different measurements in different MGP. This is also called as concurrent MGP. FIG. 2 shows an example of a single MGP in NR.

### Bandwidth Part Operation

To enable the UE power saving and avoid interference, the UE can be configured by the higher layer with a set of Bandwidth Parts (BWPs) for signal receptions (e.g., PDCCH, PDSCH etc.) by the UE (DL BWP set e.g., up to four DL BWPs) and a set of BWPs for signal transmissions (e.g., PUCCH, PUSCH) by the UE (UL BWP set e.g., up to four UL BWPs) in a serving cell e.g., SpCell (e.g., PCell, PSCell), SCell etc.

Each BWP can be associated with multiple parameters. Examples of such parameters are: BW (e.g., number of time-frequency resources (e.g., resource blocks such as 25 PRBs etc.), location of BWP in frequency (e.g., starting RB index of BWP or center frequency, etc.), subcarrier spacing (SCS), cyclic prefix (CP) length, any other baseband parameter (e.g., MIMO layer, receivers, transmitters, HARQ related parameters etc.) etc.

The UE is served (e.g., receive signals such as PDCCH, PDSCH and transmits signals such as PUCCH, PUSCH) in a serving cell only on the active BWP(s). At least one of the configured DL BWPs can be active for reception and at least one of the configured UL BWPs can be active for transmission in each serving cell. The UE can be configured to switch the active BWP based on a timer (e.g., BWP inactivity timer such as bwp-InactivityTimer), by receiving a command or a message from another node (e.g., from the BS) etc.

### Configured Grant Small Data Transmission

NR supports RRC_INACTIVE state and UEs with infrequent (periodic and/or aperiodic) data transmission (interchangeably called as small data transmission, or SDT) are generally maintained by the network not in RRC_IDLE but in the RRC_INACTIVE state. Until Rel-16, the RRC_INACTIVE state doesn't support data transmission. Hence, the UE resumes the connection (i.e., move to RRC_CONNECTED state) for any DL data reception and UL data transmission. Connection setup and subsequently release to RRC_INACTIVE state happens for each data transmission. This results in unnecessary power consumption and signaling overhead. For this reason, support for UE transmission in RRC_INACTIVE state using random access procedure is introduced in Rel-17. Small Data Transmission (SDT) is a procedure to transmit UL data from UE in RRC_INACTIVE state. SDT is performed with either random access or configured grant (CG). The case in which the UE transmits UL data with Random Access (RA) can use both 4-step RA type and 2-step RA type (above). If the UE uses 4-step RA type for SDT procedure, then the UE transmits the UL data in the Msg3. If the UE uses 2-step RA type for SDT procedure, then the UE transmits UL data in the MsgA.

Two types of Configured Grant (CG) UL transmission schemes have been supported in NR since Rel-15, referred as CG Type1 and CG Type2 in the standard. The major difference between these two types of CG transmission is that for CG Type1, an uplink grant is provided by RRC configuration and activated automatically, while in the case of CG Type2, the uplink grant is provided and activated via L1 signaling, i.e., by an UL DCI with CRC scrambled by CS-RNTI. In both cases, the spatial relation used for PUSCH transmission with Configured Grant is indicated by the uplink grant, either provided by the RRC configuration or by an UL DCI. The CG periodicity is RRC configured, and this is specified in the ConfiguredGrantConfig IE (see, e.g., TS 38.331 v16.6.0). Different periodicity values are supported in NR depending on the subcarrier spacing.

For use in SDT, the gNB may configure the UE with Configured Grant type 1 and may also configure RSRP threshold(s) for selection of UL carrier. The configuration is given in the RRCRelease message sent to the UE while in connected state (to move the UE into Inactive state), or alternatively in another dedicated RRC message, for example while the UE is in RRC_CONNECTED. Alternatively, the configuration is given in RRCRelease message after a small data transmission procedure where the UE has started the procedure in RRC_INACTIVE and where the UE stays in RRC_INACTIVE after procedure completion. The use of Configured Grant type of resource requires the UE to remain synchronous state in that the time alignment is maintained. Should the UE be out of time alignment, a RA type of procedure can be initiated instead.

In NR the positioning measurements are performed when the UE is in RRC connected state. However, in Rel-17, the UE in NR can also be configured to perform positioning measurements in RRC inactive state. Improved systems and methods for positioning are needed.

### SUMMARY

Some embodiments disclosed herein comprise methods in a User Equipment (UE) and a network node (e.g., a base station (BS), positioning node, etc.).

According to a first embodiment a UE configured to perform a positioning measurement in a first RRC state (RRC1) is triggered to transition from RRC1 to a second RRC state (RRC2), and in response to the trigger the UE adapts the ongoing positioning measurement procedure based on one or more rules, which can be pre-defined or configured by the network node. The UE may further perform the positioning measurement based on the adapted measurement procedure.

Examples of rules which may be applied by the UE in response to the triggering of the RRC state transition are:
Continuing the ongoing positioning measurement in RRC1 after the transition to RRC2:
Stopping the ongoing measurement after the transitioning to RRC2 regardless of whether it is completed or not.
Abandoning or discarding the measurement done in RRC1, and restarting the measurement after the transition to RRC2.
Postponing or delaying the RRC state transition e.g., delaying until completion of the ongoing measurement.
Not performing the RRC state transition e.g., until one or more condition is met.
Performing any one or more of the above actions or applying one or more of the above rules depending on the number of transitions (Nt) between RRC1 and RRC2. The parameter Nt can be pre-defined or configured by the network node.
Informing a network node (e.g., LMF) when one or more conditions is met that RRC state transition has occurred and receiving further information from the network node regarding the positioning measurement behavior after the RRC state transition and performing the positioning measurement based on configured behaviour. Examples of conditions are: RRC state transition, expiry of a timer, which is set upon receiving assistance data or starting the measurements (e.g., during RRC1), etc.

The UE may optionally further inform a network node about the results of the measurement adaptation.

According to a second embodiment, a network node (e.g., NN1, NN2 etc.) determines that the UE is configured to perform one or more positioning measurements and the UE may transition its RRC state from RRC1 to RRC2. The network node may configure the UE with one or more measurement rules or procedures (e.g., timing advance command, uplink power control) or triggering event (e.g., timer) to be used by the UE for determining its measurement behaviour during RRC2. Examples of measurement rules are restart, continue or abandon measurement after the transition, delay or postpone the RRC state from RRC1 to RRC2 (e.g., stay in RRC1 until the completion of the ongoing positioning measurement and/or for certain time period (ΔT)), etc.

The proposed method provides solution for any positioning methods which are supported both in low activity RRC state and high activity RRC state. For example, UL SRS based configuration when configured using low activity state and when the UE switches to connected mode. In inactive state only open loop power control is used whereas in connected state closed loop power control can be used.

In one example RRC1 and RRC2 comprising low activity RRC state and high activity RRC state respectively.

In another example RRC1 and RRC2 comprising high activity RRC state and low activity RRC state respectively.

Examples of low activity RRC state are RRC idle, RRC inactive. An example of high activity RRC state are RRC connected state.
The positioning measurement performance is enhanced in different RRC states.
The UE can perform positioning measurements even when RRC state transition occurs.
The UE behaviour in terms of positioning measurement procedure when RRC state transition occurs is predictable and well defined.
Improved UE power consumption since it might be possible to continue or resume an ongoing measurement after the transition. Because of which the UE does not always have to restart the measurement.

According to different aspects, methods, a user equipment, and a network node according to the appended independent claims are provided. Embodiments which do not fall within the scope of the claims are to be interpreted as examples useful for understanding the invention.

In some embodiments, a method performed by a UE for performing positioning measurements includes: being configured to perform a positioning measurement in a first RRC state (RRC1); being triggered to transition from RRC1 to a second RRC state (RRC2); in response to the trigger, adapting an ongoing positioning measurement procedure based on one or more rules; and performing the positioning measurement based on the adapted measurement procedure.

In some embodiments, a method performed by a network node for enabling positioning measurements includes: configuring a UE to perform a positioning measurement in a first RRC state (RRC1); triggering the user equipment to transition from RRC1 to a second RRC state (RRC2); in response to the trigger, the user equipment adapting ongoing positioning measurement procedure based on one or more rules; and receiving the positioning measurement based on the adapted measurement procedure.

In some embodiments, RRC1 comprises an RRC_INACTIVE state and RRC2 comprises an RRC_CONNECTED state.

In some embodiments, the method also includes: informing a network node about the results of the measurement adaptation.

In some embodiments, the one or more rules are pre-defined and/or configured by the network node. In some embodiments, the network node is a base station or a positioning node. In some embodiments, the network node comprises a LMF.

In some embodiments, the one or more rules comprise one or more of: continuing the ongoing positioning measurement in RRC1 after the transition to RRC2; and abandoning or discarding the ongoing positioning measurement done in RRC1 after the transition to RRC2, and restarting the ongoing positioning measurement in RRC1 after the transition to RRC2; and abandoning or discarding the ongoing positioning measurement in RRC1 after the transition to RRC2 and restarting the ongoing positioning measurement in RRC1 after the transition to RRC2.

In some embodiments, the method also includes continuing the ongoing positioning measurement after the transition to RRC2 if the positioning measurement comprises only a downlink measurement component and an uplink measurement component.

In some embodiments, the method also includes: continuing the ongoing positioning measurement after the transition to RRC2 if the positioning measurement comprises: RSTD and/or PRS-RSRP.

In some embodiments, the method also includes: continuing the ongoing positioning measurement after the transition to RRC2 if the positioning measurement comprises only a downlink measurement component. restarting the ongoing positioning measurement in RRC1 after the transition to RRC2 if the positioning measurement comprises a downlink measurement component and an uplink measurement component; or abandoning or discarding the ongoing positioning measurement in RRC1 after the transition to RRC2 and restarting the ongoing positioning measurement in RRC1 after the transition to RRC2 if the positioning measurement comprises a downlink measurement component and an uplink measurement component.

In some embodiments, the method also includes: restarting the ongoing positioning measurement done in RRC1 after the transition to RRC2 if the positioning measurement comprises: UE Rx-Tx time difference measurement.

In some embodiments, the method also includes: abandoning or discarding the ongoing positioning measurement done in RRC1, and restarting the ongoing positioning measurement after the transition to RRC2 if the positioning measurement comprises: UE Rx-Tx time difference measurement.

In some embodiments, the UE operates in a NR communications network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a New Radio (NR) architecture;

FIG. 2 shows an example of a single Measurement Gap Pattern (MGP) in NR;

FIG. 3 illustrates an example flow diagram where a UE in a high activity state keeps track of any inactivity (data connection release) and before connection is terminated the method ensures that the UE can stay in the high activity Radio Resource Control (RRC) state for Positioning purposes, according to some embodiments of the present disclosure;

FIG. 4 illustrates an example of a UE performing and adapting positioning measurement procedure under RRC state transition from RRC1 to RRC2 e.g., from RRC inactive to RRC connected or vice versa, according to some embodiments of the present disclosure;

FIG. 5 illustrates one example of a cellular communications system according to some embodiments of the present disclosure;

FIGS. 6 and 7 illustrate example embodiments in which the cellular communication system of FIG. 5 is a Fifth Generation (5G) System (5GS);

FIG. 8 illustrates a method performed by a UE for performing positioning measurements according to some embodiments of the present disclosure;

FIG. 9 illustrates a method performed by a network node for enabling positioning measurements according to some embodiments of the present disclosure;

FIG. 10 is a schematic block diagram of a radio access node according to some embodiments of the present disclosure;

FIG. 11 is a schematic block diagram that illustrates a virtualized embodiment of the radio access node of FIG. 10 according to some embodiments of the present disclosure;

FIG. 12 is a schematic block diagram of the radio access node of FIG. 10 according to some other embodiments of the present disclosure;

FIG. 13 is a schematic block diagram of a User Equipment device (UE) according to some embodiments of the present disclosure;

FIG. 14 is a schematic block diagram of the UE of FIG. 13 according to some other embodiments of the present disclosure;

FIG. 15 illustrates a telecommunication network connected via an intermediate network to a host computer in accordance with some embodiments of the present disclosure;

FIG. 16 is a generalized block diagram of a host computer communicating via a base station with a UE over a partially wireless connection in accordance with some embodiments of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment of the present disclosure;

FIG. 19 is a flowchart illustrating a method implemented in a communication system in accordance with one embodiment of the present disclosure; and

FIG. 20 is a flowchart illustrating a method implemented in a communication system in accordance with one embodiment of the present disclosure.

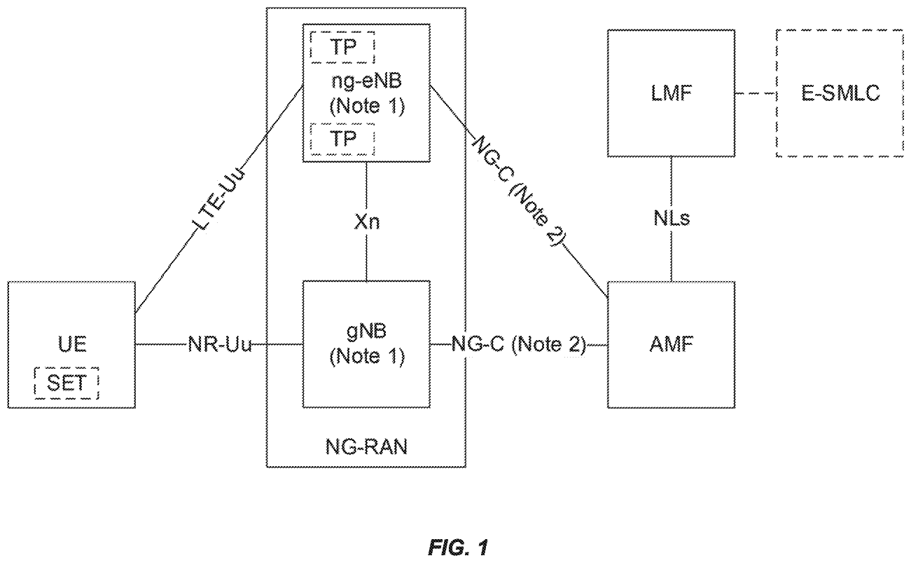

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Examples of network nodes are NodeB, base station (BS), multi-standard radio (MSR) radio node such as MSR BS, eNodeB, gNodeB. MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), RRU, RRH, nodes in distributed antenna system (DAS), core network node (e.g., MSC, MME etc.), O&M, OSS, SON, location server (e.g., LMF, E-SMLC, SUPL SLP) etc. The location server may also be called as positioning node or positioning server.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal such as PSS, SSS, CSI-RS, DMRS, signals in SSB, DRS, CRS, PRS etc. Examples of UL physical signals are reference signal such as SRS, DMRS etc. The term physical channel refers to any channel carrying higher layer information e.g., data, control etc. Examples of physical channels are: PBCH, NPBCH, PDCCH, PDSCH, sPUCCH, sPDSCH. SPUCCH, sPUSCH, MPDCCH, NPDCCH, NPDSCH, E-PDCCH, PUSCH, PUCCH, NPUSCH, etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

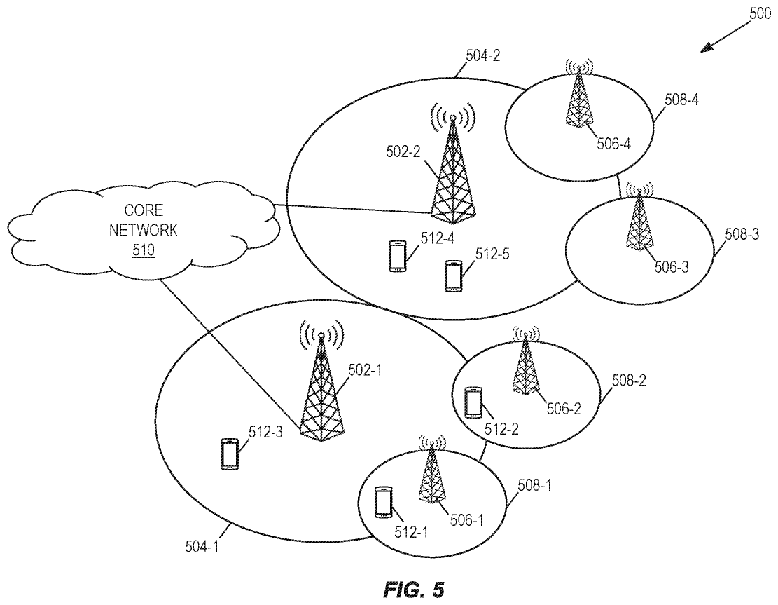

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC). In this example, the RAN includes base stations 502-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or RRHs, or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs, but the present disclosure is not limited thereto.

In NR the positioning, measurements are performed when the UE is in RRC connected state. However, in Rel-17, the UE in NR can also be configured to perform positioning measurements in RRC inactive state. The UE may change its RRC states depending on the available data for transmission, type of service etc. The positioning measurement procedures in RRC inactive and RRC connected states may be very different. The UE behavior in terms positioning measurements when changing the RRC states is undefined. This may lead to multiple problems. For example, the positioning measurement may not be performed accurately. The UE may lose or drop the ongoing data transmission due to lack of UE specified UE behavior.

Positioning measurements in Rel-17 has been defined for RRC Inactive state and it is expected that this will be extended to idle mode also in Rel-18. The main benefit considered for inactive state and idle state (low activity state, dormant states) is power saving for the UE for positioning measurement. However, in terms of positioning accuracy it would be expected that UE has same requirement as in connected mode (high activity state); i.e., the performed measurement should be of good quality and the estimated positioning should be sufficiently accurate. The UE may have challenges in meeting the requirements in inactive state mainly because the assistance data would be generic (e.g., for multiple UEs) rather than specific to be used by the UE. When the UE is LPP connected, the NW has good understanding but in inactive/idle state the NW may not know the exact requirements of UE. UE may switch to connected state because of some other service type such as voice call; in such case status of positioning measurements configured for inactive/idle mode is unclear. The expected UE behavior with respect to positioning measurement (whether to continue or halt) or applicability of positioning configuration and/or assistance data is unclear.

Systems and methods for performing positioning measurements are provided. In some embodiments, a method performed by a UE for performing positioning measurements includes one or more of: being configured to perform a positioning measurement in a first Radio Resource Control (RRC) state (RRC1); being triggered to transition from RRC1 to a second RRC state (RRC2); in response to the trigger, adapting the ongoing positioning measurement procedure based on one or more rules; performing the positioning measurement based on the adapted measurement procedure; and informing a network node about the results of the measurement adaptation. In this way, the positioning measurement performance is enhanced in different RRC states; the UE can perform positioning measurements even when RRC state transition occurs; the UE behaviour in terms of positioning measurement procedure when RRC state transition occurs is predictable and well defined; improved UE power consumption since it might be possible to continue or resume an ongoing measurement after the transition; the UE does not always have to restart the measurement.

Some embodiments disclosed herein comprise a method in a UE and a network node (e.g., BS, positioning node etc.).

According to a first embodiment a UE configured to perform a positioning measurement in a first RRC state (RRC1) is triggered to transition from RRC1 to a second RRC state (RRC2), and in response to the trigger the UE adapts the ongoing positioning measurement procedure based on one or more rules, which can be pre-defined or configured by the network node. The UE may further perform the positioning measurement based on the adapted measurement procedure. Examples of rules which may be applied by the UE in response to the triggering of the RRC state transition are:
Continuing the ongoing positioning measurement in RRC1 after the transition to RRC2:
Stopping the ongoing measurement after the transitioning to RRC2 regardless of whether it is completed or not.
Abandoning or discarding the measurement done in RRC1, and restarting the measurement after the transition to RRC2.
Postponing or delaying the RRC state transition e.g., delaying until completion of the ongoing measurement.
Not performing the RRC state transition e.g., until one or more condition is met.
Performing any one or more of the above actions or applying one or more of the above rules depending on the number of transitions (Nt) between RRC1 and RRC2. The parameter Nt can be pre-defined or configured by the network node.
Informing a network node (e.g., LMF) when one or more conditions is met that RRC state transition has occurred and receiving further information from the network node regarding the positioning measurement behavior after the RRC state transition and performing the positioning measurement based on configured behaviour. Examples of conditions are: RRC state transition, expiry of a timer, which is set upon receiving assistance data or starting the measurements (e.g., during RRC1) etc.

The UE may further inform a network node about the results of the measurement adaptation. According to a second embodiment, a network node (e.g., NN1, NN2 etc.) determines that the UE configured to perform one or more positioning measurements and the UE may transition its RRC state from RRC1 to RRC2. The network node may configure the UE with one or more measurement rules or procedures (e.g., timing advance command, uplink power control) or triggering event (e.g., timer) to be used by the UE for determining its measurement behaviour during RRC2. Examples of measurement rules are restart, continue or abandon measurement after the transition, delay or postpone the RRC state from RRC1 to RRC2 e.g., stay in RRC1 until the completion of the ongoing positioning measurement and/or for certain time period (ΔT) etc.

The proposed method provides solution for any positioning methods which are supported both in low activity RRC state and high activity RRC state. For example, UL SRS based configuration when configured using low activity state and when the UE switches to connected mode. In inactive state only open loop power control is used whereas in connected state closed loop power control can be used.

In one example RRC1 and RRC2 comprising low activity RRC state and high activity RRC state respectively.

In another example RRC1 and RRC2 comprising high activity RRC state and low activity RRC state respectively.

Examples of low activity RRC state are RRC idle, RRC inactive. An example of high activity RRC state are RRC connected state.

The positioning measurement performance is enhanced in different RRC states. The UE can perform positioning measurements even when RRC state transition occurs. The UE behaviour in terms of positioning measurement procedure when RRC state transition occurs is predictable and well defined. Improved UE power consumption since it might be possible to continue or resume an ongoing measurement after the transition. Because of which the UE does not always have to restart the measurement.

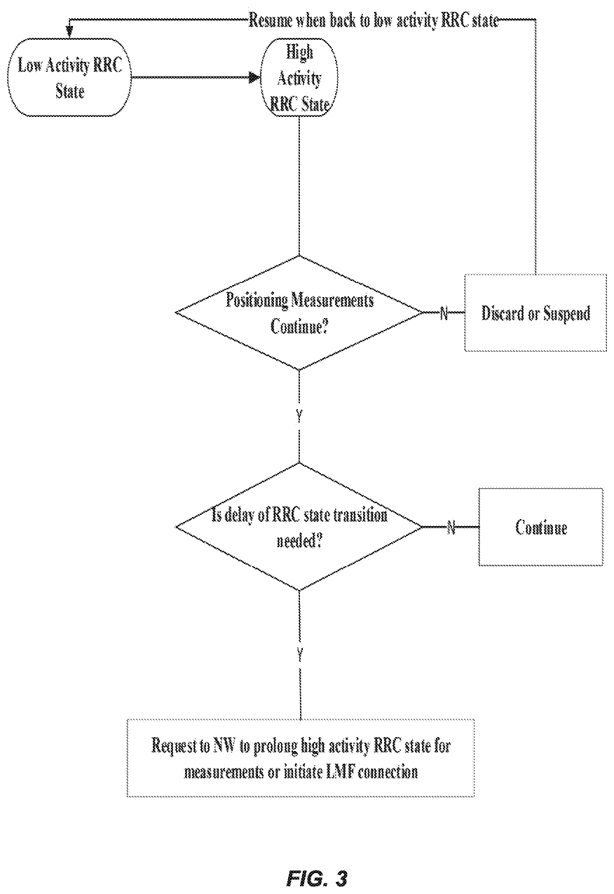

FIG. 3 illustrates an example flow diagram where a UE in a high activity state keeps track of any inactivity (data connection release) and before connection is terminated the method ensures that the UE can stay in the high activity RRC state for Positioning purposes, according to some embodiments of the present disclosure.

### EMBODIMENTS

### Scenario for Embodiments

The scenario comprises a UE served by at least a first cell (cell1) which in turn is served or managed by a first network node (NN1). Examples of NN1 are base station, gNB etc. The UE may be configured by a second network node (NN2) to perform one or more positioning measurements on cells of one or more positioning frequency layers (PFL) in any of the RRC states. A PFL may also be called as carrier, carrier frequency, layer, frequency layer etc. A PFL may be serving carrier frequency (e.g., PCC, SCC, PSC etc.) or non-serving carrier frequency (e.g., inter-frequency carrier, inter-RAT carrier etc.). In one example NN2 is the same as NN1. In another example NN2 is a location server e.g., LMF. The UE uses the positioning measurement results for performing one or more operational tasks e.g., report the positioning measurement results to one or more nodes e.g., NN1, NN2, using the positioning measurement results for determining its position etc. The UE may also meet one or more positioning measurement requirements. Examples of positioning measurement requirements are measurement time, measurement accuracy, measurement reporting periodicity, number of cells measured over the measurement time etc. Examples of measurement time are cell identification time, evaluation period or measurement period (e.g., L1 measurement period), etc. Examples of measurement accuracy are PRS-RSRP accuracy (e.g., within ±X1 dB with respect to reference PRS-RSRP value), RSTD accuracy (e.g., within ±X2 Tc with respect to reference RSTD value), UE Rx-Tx accuracy (e.g., within ±X3 Tc with respect to reference UE Rx-Tx value). Tc is basic time unit in NR; 1 Tc≈0.5 ns.

### Embodiment #1: Method in UE of Adapting Positioning Measurement Procedure Based on RRC State Transition

According to a first embodiment, a UE is operating in a first RRC state (RRC1) and during the state the UE is configured by NN2 to perform one or more positioning measurements on one or more cells of at least one PFL. The UE may be configured with positioning measurements by receiving positioning assistance data, which may include for example reference signals (RS) configuration in different cells of the PFL. Examples of reference signals are PRS, SRS, etc. Examples of reference RS configuration parameters are PRS resource set information, SRS resource set information, etc.

While performing the positioning measurements in RRC1 state, the UE is triggered to perform RRC state transition to a second RRC state (RRC2). The RRC state transition is interchangeably be called as RRC state change, RRC state switching, RRC state modification etc. In one example RRC1 and RRC2 are low activity and high activity RRC states respectively. In another example RRC1 and RRC2 are high activity and low activity RRC states respectively. The UE may be triggered to perform the RRC state transition or determines that it should perform RRC state transition upon fulfilling one or more conditions. Examples of conditions are:
Arrival of data in the UE buffer. In this case RRC1 and RRC2 can be low activity and high-activity RRC states respectively.
Receiving a message from the network node e.g.,
   paging message, scheduling command, etc. from cell1. In this case RRC1 and RRC2 can be low activity and high activity RRC states respectively.
   Explicit message to change the RRC state e.g., from cell1. In this case RRC1 and RRC2 can be any of low activity and high activity RRC states.
After certain inactive time period e.g., after expiry of timer which may have started after no data was received and/or transmitted by the UE. In this case RRC1 and RRC2 can be high activity and low activity RRC states respectively.

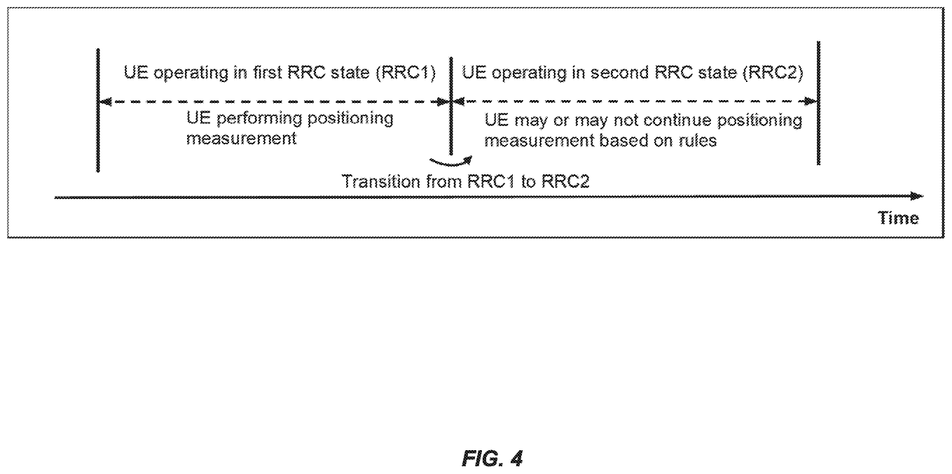

FIG. 4 illustrates an example of a UE performing and adapting positioning measurement procedure under RRC state transition from RRC1 to RRC2 e.g., from RRC inactive to RRC connected or vice versa, according to some embodiments of the present disclosure. In response to the triggering of the RRC state transition, the UE may adapt the ongoing positioning measurement procedure based on one or more rules as shown in FIG. 4. The UE further uses the adapted positioning measurement procedure for performing the measurements. The UE determines the one or more rules based on pre-defined information or by receiving a configuration message from the network node e.g., NN1, NN2, etc. The rules may also be specified in terms of one or more requirements, which the UE needs to meet when performing the positioning measurements. Examples of rule are elaborated below:
1. Continuing ongoing measurement after transition unconditionally: In a first example of the rule, the UE performs the RRC state transition (from RRC1 to RRC2), and continues the ongoing positioning measurement (which was being performed in RRC1) after the transition to RRC2 regardless of any condition. In this case the measurement period (Tm′) of the positioning measurement spans partially during RRC1 and partially during RRC2. For example, the UE may combine S1 number of samples obtained during RRC1 and S2 number of samples obtained during RRC2 to obtain the final measurement results, M, over Tm′. S1 and S2 may or may not be the same. Samples S1 and S2 may be combined by one or more functions. Examples of function are average, sum, maximum, product, x^{th} percentile etc. In one example Tm′=Tm. In another example the UE is allowed to extend the measurement time compared to the reference measurement time (Tm) i.e., Tm′>Tm e.g., Tm′=8+Tm. Where Tm is the measurement period of the measurement performed entirely during RRC1 and δ is a margin, which may be pre-defined or configured by the network node. In one example, δ may correspond to a time period over which the RRC state changes. In another example, δ may correspond to or is function of or depends on the time period or duration of the signal interruption (e.g., Y1 ms, Y2 time resources) in one or more serving cells occurring due to the transitioning from RRC1 to RRC2. During the interruption time period the UE may not or is not expected to transmit and/or receive signals in one or more serving cells. In another example of a measurement period for a positioning measurement when the UE continues the ongoing measurement after the RRC state transition unconditionally is expressed by a parameter, Tx. The parameter, Tx, can be expressed as or determined by the UE using a following function g(.):

$$Tx = g ( Tx 1 , Tx 2 , α1 , α2 , β )$$

Examples of functions are maximum, sum, product, minimum, ceiling, floor, xth percentile, combinations of two or more functions (e.g. maximum and sum, or sum and product etc).

One specific example of Tx is given below:

$$Tx = Tx 1 + Tx 2 + α1 + α2 + β$$

Another specific example of Tx is given below:

$$Tx = MAX ( Tx 1 , Tx 2 ) + α1 + α2 + β$$

The specific example of Tm″ above may be expressed as the positioning measurement is the sum of one or more margins (e.g., α1, α2, β etc.) and the longest or the maximum of: the positioning measurement period in RRC1 (e.g., in RRC_INACTIVE state) and the positioning measurement period in RRC2 (e.g. RRC_CONNECTED state)

Where:
Tx1 is the measurement period of the positioning measurement if it is entirely performed in RRC1.
Tx2 is the measurement period of the positioning measurement if it is entirely performed in RRC2.
α1 is margin due to measurement in RRC1. In one example, α1-0. In another example, α1≠0 e.g. α1>0.
α2 is margin due to measurement in RRC2. In one example, α1-0. In another example, α1≠0 e.g. α1>0.
β is margin due to one or more procedures involved or needed during the state transition between RRC1 and RRC2. It may also be called as state transition time or delay. Examples of procedures during the RRC state transition are gap configuration, timing advance acquisition, uplink power control, message reception, transmission and/or processing procedure. In one example β is the same for state transition from low activity RRC state to high activity RRC state or from high activity RRC state to low activity RRC state. In one example β=β1 for RRC state transition from low activity RRC state to high activity RRC state and β=β2 for RRC state transition from high activity RRC state to low activity RRC state; where β1≠B2. In one example, β=0. In another example, β≠0 e.g. B>0.
2. Continuing ongoing measurement after transition conditionally: In another of the rule the UE performs the RRC state transition (from RRC1 to RRC2), and also continues performing the ongoing positioning measurement (which was being performed in RRC1) after the transition to RRC2 provided that one or more conditions are met or will be met after the transition; otherwise the UE does not continue the measurement after the transition and the already performed measurement samples are discarded. In this case in one example the UE may not extend the measurement time with respect to reference measurement time (e.g., Tm′=Tm). In another example the UE may extend the measurement time with respect to reference measurement time (e.g., Tm′>Tm; Tm′=δ+Tm). In another example of a measurement period for a positioning measurement when the UE continues the ongoing measurement after the RRC state transition conditionally is expressed by a parameter, Tx. The parameter Tx, the associated function (Tx=g (Tx1, Tx2, α1, α2, β)) and examples are the same as described earlier. Examples of one or more conditions to be met by the UE for continue performing the measurement are:
   a. In one example of the condition whether the UE continues performing the ongoing measurement after the transition is based on the activity level of RRC1 and/or RRC2. In one example the UE continues the ongoing measurement after the transition if RRC1 is the low activity RRC state (e.g., RRC inactive); otherwise the UE does not continue performing the ongoing measurement. In another example the UE continues performing the ongoing measurement if RRC1 is the high activity RRC state (e.g., RRC connected); otherwise the UE does not continue performing the ongoing measurement.
   b. In another example of the condition whether the UE continues performing the ongoing measurement after the transition is based on whether the UE needs measurement gaps for performing the positioning measurement after the transition. In one example the UE continues performing the ongoing measurement if the UE can perform the positioning measurement without measurement gaps; otherwise the UE does not continue performing the measurement after the transition. In another example the UE continues performing the ongoing measurement after the transition provided that after the transition if the UE needs measurement gaps for the measurement then at least one MGP is configured or available at the UE after the transition; otherwise the UE does not continue performing the measurement after the transition. In these example RRC1 and RRC2 may be low activity and high activity RRC states respectively.
   c. In another example of the condition whether the UE continues performing the ongoing measurement after the transition is based on type of reference signal (RS) configured for performing the positioning measurement. Examples of RS types are PRS, SRS etc. In one example the UE continues performing the ongoing measurement if only DL RS (e.g., PRS) is configured for positioning measurement; otherwise the UE does not continue performing the ongoing measurement. In another example the UE continues performing the ongoing measurement if both DL RS (e.g., PRS) and UL RS (e.g., SRS) are configured for positioning measurement; otherwise the UE does not continue performing the ongoing measurement. In another example the UE continues performing the ongoing measurement if the UE is not configured with certain type of RS for positioning measurements; otherwise the UE does not continue performing the ongoing measurement. In another example the UE continues performing the ongoing measurement if the UE is not configured with UL RS (e.g., SRS) for positioning measurement; otherwise the UE does not continue performing the ongoing measurement.
   d. In another example of the condition whether the UE continues performing the ongoing measurement after the transition is based on type of the positioning measurement. Examples of positioning measurement types are unidirectional and bidirectional measurements. The former involves measurement components only in one direction e.g., uplink or downlink. The latter involves uplink and downlink measurement components. Examples of unidirectional measurements are RSTD, PRS-RSRP etc. Examples of bidirectional measurements are UE Rx-Tx time difference etc. In one example the UE continues performing the ongoing measurement if the positioning measurement is a bidirectional measurement; otherwise the UE does not continue performing the ongoing measurement. In another example the UE continues performing the ongoing measurement if positioning measurement is a unidirectional measurement; otherwise the UE does not continue performing the ongoing measurement.
   e. In another example of the condition whether the UE continues performing the ongoing measurement after the transition is based on whether the bandwidth (BW) of RS used for performing the positioning measurement is within a BW of the active bandwidth part (BWP) after the transition. In one example the UE continues performing the ongoing measurement if the BW of the RS used for the measurement is within the BW of the active BWP; otherwise the UE does not continue performing the ongoing measurement. In these example RRC1 and RRC2 may be any of the low activity and high activity RRC states.
   f. In another example of the condition whether the UE continues performing the ongoing measurement after the transition is based on the number of configured positioning measurements. In one example the UE continues performing the ongoing measurement if the UE is configured to perform more than one positioning measurements (e.g., RSTD and PRS-RSRP, or UE Rx-Tx and PRS-RSRP); otherwise the UE does not continue performing the measurement after the transition.
   g. In another example of the condition whether the UE continues performing the ongoing measurement after the transition is based on whether the UE has or will have valid time advance command (TA) after the transition. A TA is valid if the time alignment timer is running; otherwise it is invalid. In one example the UE continues performing the ongoing measurements if the UE has or will have valid time advance command after the transition; otherwise the UE does not continue performing the measurement after the transition.
   h. In another example of the condition whether the UE continues performing the ongoing measurement after the transition is based on whether the UE needs time advance command (TA) after the transition. In one example the UE continues performing the ongoing measurements if the UE does not need time advance command after the transition; otherwise the UE does not continue performing the measurement after the transition.
   i. In another example of the condition whether the UE continues performing the ongoing measurement after the transition is based on type of the configured positioning method for performing positioning measurements. In one example the UE continues performing the ongoing measurements if the UE is configured with DL-TDOA; otherwise the UE does not continue performing the measurement after the transition. In another example the UE continues performing the ongoing measurements if the UE is configured with multi-RTT; otherwise the UE does not continue performing the measurement after the transition.
   j. In another example of the condition whether the UE continues performing the ongoing measurement after the transition is based on whether the UE is configured or expected to be configured (e.g., via higher layer signaling by network node or based on pre-defined rule) with one or more relaxed measurement criteria (RMC) in the RRC2. Examples of RMCs include: stationary, low mobility, not-at-cell-edge, or combination thereof. For example, a UE meets stationary criterion or low mobility criterion if received signal level (e.g., RSRP) does not change by more than certain margin within certain time period. A UE meets not-at-cell-edge criterion if received signal level (e.g., RSRP, RSRQ, SNR, SINR etc.) is above certain threshold for more than certain time period. If the RMC criterion is fulfilled by the UE then the UE is allowed to perform a relaxed measurement, which meets one or more relaxed measurement requirements. An example of a relaxed requirement is a measurement time (e.g., evaluation time, measurement period etc.) which is longer than a measurement time when no relaxation is applied. For example, a relaxed measurement time (Trm) for a measurement performed when RMC is configured and met is Trm=K*Tnm; where K>1 (e.g., K=3) and Tnm is the measurement time for the same measurement performed without relaxation (e.g., when RMC is not configured and/or RMC is not met). In one example, the UE may continue the measurement after transition to RRC2 if UE is not configured with any relaxation criterion. In another example, the UE may not continue the measurement after transition to RRC2 if the UE is configured with one or more relaxed measurement criteria. The rule may further depend on the type of relaxation (e.g., whether relaxation is applied on serving cell measurements (e.g., relaxation to measurements for RLM and/or BFD) or on neighbor cell measurements (e.g., RSRP, RSRQ etc.). In yet another example, the UE may not continue the measurement after transition to RRC2 if UE is configured with relaxation criteria and UE has fulfilled those criteria. In yet another example, the UE may continue the measurement after transition to RRC2 if UE is configured with relaxation criteria, but it has not fulfilled the configured RMC in RRC2.
   k. In another example of the condition whether the UE continues performing the ongoing measurement after the transition is based on a relation between the requirements to be met by the UE in RRC1 and RRC2. In one example, the UE may continue performing the ongoing measurement in RRC2 if one or more measurement requirements for measurement performed in RRC2 are more relaxed in RRC1, otherwise it may not continue performing the measurement in RRC2. In another example, the UE may continue performing the ongoing measurement in RRC2 if the requirements for measurements performed in RRC2 are more stringent (e.g., shorter measurement time compared to no relaxed measurement) than requirements for measurements performed in RRC1, otherwise it may not continue performing the measurement. In one example, the UE may continue performing the ongoing measurement after transition to RRC2 but meets the requirements associated with the RRC1 for a certain time period (after the transition). This reduces the risk of failing the ongoing measurement upon transitioning into the new RRC state.
   l. In another example of the condition whether the UE continues performing the ongoing measurement after the transition is based on whether the transition requires interruption of signals in one or more serving cell, i.e., whether the connection is interrupted when transitioning from RRC1 to RRC2. In one example, the UE may continue the ongoing measurement if transition does not require interruption, otherwise it may not continue the measurement. In a second example, the UE may continue the measurement even if transition involves interruption, but the interruption length is below a certain length (e.g., X1 ms or less, or X2 time resources or less), otherwise it may not continue performing the measurement.
   m. In another example of the condition whether the gNB continues performing the ongoing measurement after the UE transition from RRC1 to RRC2 when UE has been configured to transmit UL SRS for positioning purposes. In one of the RRC state the configured grant for small data transmission may have been provided which may not be applicable in RRC2. Further, the mechanism of power control may differ in between these two states with respect to UL SRS Transmission. In one example, the gNB may continue performing the ongoing measurement in RRC2 if UE changes the power control method suitable for RRC2. If the UE is unable, then the measurements are either suspended or discarded.
3. Stopping ongoing measurement due to transition: In another example of the rule the UE may stop performing the ongoing measurement after the transitioning to RRC2 regardless of whether the measurement has been completed or not. In one example the UE may discard the measurement results obtained while in RRC1. In another example the UE may transmit the measurement results (partial results e.g., based on S1 samples) obtained while in RRC1 to a network node e.g., NN1, NN2, etc. In yet another example, the UE may transmit the measurement results that was performed in RRC1 if it fulfills one or more requirements (e.g., the accuracy requirements of the measurement e.g., PRS-RSRP accuracy is within ±X3 dB with respect to reference accuracy, RSTD accuracy is within ±X4 Tc with respect to reference accuracy; 1 Tc≈0.5 ns). In another example if the minimum requirements are based on X5 number of samples (e.g., X5=5 samples e.g., 5 samples over the measurement period to obtain the measurement results) in minimum side condition (e.g., SINR ≥−6 dB), but the UE is able to fulfill the accuracy requirements in better side conditions (e.g., SINR >0 dB) using X6 number of samples (where X6<X5 e.g., X6=3 samples) already and the UE has already taken those X6 samples then UE may transmit the measurement result based on X6.
4. Restarting measurement after transition unconditionally: In another example of the rule the UE may abandon or discard or drop the measurement done in RRC1, and the UE may further restart the measurement after the transition to RRC2. In this case the UE discards the S1 samples obtained during RRC1 and instead obtains and uses S2 number of samples during RRC2 for obtaining the final measurement results, M2, over the measurement time Tm2. In one example Tm2 and Tm (measurement done completely under RRC1) may be the same. In another example Tm2 and Tm may be different. In one example Tm2>Tm. In another example Tm2<Tm. In another example of a measurement period for a positioning measurement when the UE restarts the measurement after the RRC state transition unconditionally is expressed by a parameter, Tx. The parameter Tx, the associated function (Tx=g (Tx1, Tx2, α1, α2, β)) and examples are the same as described earlier.
5. Restarting measurement after transition conditionally: In another example of the rule the UE may abandon or discard or drop the measurement done in RRC1, and the UE may further restart the measurement after the transition to RRC2 provided that one or more conditions are met; otherwise the UE does not restart the measurement after the transition RRC2. In the latter case in one example the UE may discard the measurement performed during RRC1 e.g., S1 samples are dropped. In another example the UE may transmit the measurement results (partial results e.g., based on S1 samples) obtained while in RRC1 to a network node e.g., NN1, NN2 etc. In another example of a measurement period for a positioning measurement when the UE restarts the measurement after the RRC state transition conditionally is expressed by a parameter, Tx. The parameter Tx, the associated function (Tx=g (Tx1, Tx2, α1, α2, β)) and examples are the same as described earlier. Examples of one or more conditions to be met by the UE for restarting the measurement are:
   a. In one example of the condition whether the UE restarts the ongoing measurement after the transition is based on the activity level of RRC1 and/or RRC2. In one example the UE restarts the ongoing measurement after the transition if RRC1 is the low activity RRC state (e.g., RRC inactive); otherwise the UE does not restart the ongoing measurement. In another example the UE restarts the ongoing measurement if RRC1 is the high activity RRC state (e.g., RRC connected); otherwise the UE does not restart the ongoing measurement.
   b. In another example of the condition whether the UE restarts the positioning measurement after the transition is based on whether the UE needs gaps for measurements after the transition. In one example the UE restarts the ongoing measurement if the UE can perform the positioning measurement without measurement gaps; otherwise the UE does not restart the measurement after the transition. In another example the UE restarts the ongoing measurement after the transition provided that after the transition if the UE needs measurement gaps for the measurement then at least one MGP is configured or available at the UE after the transition; otherwise the UE does not restart the measurement after the transition. In these examples RRC1 and RRC2 may be low activity and high activity RRC states respectively.
   c. In another example of the condition whether the UE restarts the ongoing measurement after the transition is based on type of reference signal (RS) configured for performing the positioning measurement. In one example the UE restarts the ongoing measurement if only DL RS (e.g., PRS) is configured for positioning measurement; otherwise, the UE does not restart the ongoing measurement. In another example the UE restarts the ongoing measurement if both DL RS (e.g., PRS) and UL RS (e.g., SRS) are configured for positioning measurement; otherwise, the UE does not restart the ongoing measurement. In another example the UE restarts the ongoing measurement if the UE is not configured with certain type of RS for positioning measurements; otherwise, the UE does not restart the ongoing measurement. In another example the UE restarts the ongoing measurement if the UE is not configured with UL RS (e.g., SRS) for positioning measurement; otherwise, the UE does not restart the ongoing measurement.
   d. In another example of the condition whether the UE restarts the ongoing measurement after the transition is based on type of the positioning measurement. In one example the UE restarts the ongoing measurement if the positioning measurement is a bidirectional measurement; otherwise, the UE does not restart the ongoing measurement. In another example the UE restarts the ongoing measurement if positioning measurement is a unidirectional measurement; otherwise, the UE does not restart the ongoing measurement.
   e. In another example of the condition whether the UE restarts the ongoing measurement after the transition is based on whether the bandwidth (BW) of RS used for performing the positioning measurement is within a BW of the active bandwidth part (BWP) after the transition. In one example the UE restarts the ongoing measurement if the BW of the RS used for the measurement is within the BW of the active BWP; otherwise, the UE does not restart the ongoing measurement. In these example RRC1 and RRC2 may be any of the low activity and high activity RRC states.
   f. In another example of the condition whether the UE restarts the ongoing measurement after the transition is based on the number of configured positioning measurements. In one example the UE restarts the ongoing measurement if the UE is configured to perform more than one positioning measurements (e.g., RSTD and PRS-RSRP, or UE Rx-Tx and PRS-RSRP); otherwise, the UE does not restart the measurement after the transition.
   g. In another example of the condition whether the UE restarts the ongoing measurement after the transition is based on whether the UE has or will have valid time advance command (TA) after the transition. In one example the UE restarts the ongoing measurements if the UE has or will have valid time advance command after the transition; otherwise, the UE does not restart the measurement after the transition.
   h. In another example of the condition whether the UE restarts the ongoing measurement after the transition is based on whether the UE needs time advance command (TA) after the transition. In one example the UE restarts the ongoing measurements if the UE does not need time advance command after the transition; otherwise, the UE does not restart the measurement after the transition.
   i. In another example of the condition whether the UE restarts the ongoing measurement after the transition is based on type of the configured positioning method for performing positioning measurements. In one example the UE restarts the ongoing measurements if the UE is configured with DL-TDOA; otherwise, the UE does not restart the measurement after the transition. In another example the UE continues performing the ongoing measurements if the UE is configured with multi-RTT; otherwise, the UE does not restart the measurement after the transition.
   j. In another example of the condition whether the UE restarts the ongoing measurement after the transition is based on whether the UE is configured or expected to be configured (e.g., via higher layer signaling by network node or based on pre-defined rule) with one or more relaxed measurement criteria (RMC) in the RRC2. In one example, the UE may restart the measurement after transition to RRC2 if UE is not configured with any relaxation measurement criterion. In another example, the UE may not restart the measurement after transition to RRC2 if the UE is configured with one or more relaxed measurement criteria. The rule may further depend on the type of relaxation (e.g., whether relaxation is applied on serving cell measurements (e.g., relaxation to measurements for RLM and/or BFD) or on neighbor cell measurements (e.g., RSRP, RSRQ etc.). In yet another example, the UE may not restart the measurement after transition to RRC2 if UE is configured with relaxation criteria and UE has fulfilled those criteria. In yet another example, the UE may restart the measurement after transition to RRC2 if UE is configured with relaxation criteria, but it has not fulfilled the configured RMC in RRC2.
   k. In another example of the condition whether the UE restarts the ongoing measurement after the transition is based on a relation between the requirements to be met by the UE in RRC1 and RRC2. In one example, the UE may restart performing the ongoing measurement in RRC2 if one or more measurement requirements for measurement performed in RRC2 are more relaxed in RRC1, otherwise it may not restart the measurement in RRC2. In another example, the UE may restart the ongoing measurement in RRC2 if the requirements for measurements performed in RRC2 are more stringent (e.g., shorter measurement time compared to no relaxed measurement) than requirements for measurements performed in RRC1; otherwise it may not restart the measurement. In one example, the UE may restart the ongoing measurement after transition to RRC2 but meets the requirements associated with the RRC1 for a certain time period (after the transition). This reduces the risk of failing the ongoing measurement upon transitioning into the new RRC state.
   l. In another example of the condition whether the UE restarts the ongoing measurement after the transition is based on whether the transition requires interruption of signals in one or more serving cell, i.e., whether the connection is interrupted when transitioning from RRC1 to RRC2. In one example, the UE may restart the ongoing measurement if transition does not require interruption; otherwise, it may not restart the measurement. In a second example, the UE may restart the measurement even if transition involves interruption, but the interruption length is below a certain length (e.g., X3 ms or less, or X4 time resources or less), otherwise it may not restart the measurement.
6. Postponing RRC state transition unconditionally: In another example of the rule the UE may postpone or delay or defer the RRC state transition from RRC1 to RRC2. In one example the postponing may comprise, the UE staying in RRC1 until at least the UE completes the ongoing measurement in RRC1. In another example the postponing may comprise, the UE staying or remaining in RRC1 over certain maximum time period (ΔT) from the moment the state transition is triggered. ΔT may be pre-defined or configured by the network node. During the extended time (ΔT) spent in RRC1 the UE continues performing the ongoing measurement.
7. Postponing RRC state transition conditionally: In another example of the rule the UE may postpone or delay or defer the RRC state transition from RRC1 to RRC2 provided that one or more conditions are met; otherwise, the UE performs the transition without any delay due to positioning measurement. Like in example 5, in one example the UE may stay in RRC1 until at least the UE completes the ongoing measurement in RRC1 or in another example the UE may stay in RRC1 over ΔT in RRC1 after the state transition is triggered at the UE. Examples of one or more conditions to be met by the UE for postponing the RRC state transitions are:
   a. One example of the condition for postponing the transition is based on the activity level of RRC1 and/or of RRC2. In one example the UE postpones the transition if RRC1 is the low activity RRC state (e.g., RRC inactive); otherwise, the UE does not postpone the transition. In another example the UE postpones the transition if RRC1 is the high activity RRC state (e.g., RRC connected); otherwise, the UE does not postpone the transition.
   b. Another example of the condition for postponing the transition is based on the type of positioning measurements. In one example the UE postpones the transition if positioning measurement is a bidirectional measurement; otherwise, the UE does not postpone the transition. In another example the UE postpones the transition if positioning measurement is a unidirectional measurement; otherwise, the UE does not postpone the transition.
   c. Another example of the condition for postponing the transition is based on the type of RS configured for positioning measurements. In one example the UE postpones the transition if only DL RS (e.g., PRS) is configured for positioning measurement; otherwise, the UE does not postpone the transition. In another example the UE postpones the transition if both DL RS (e.g., PRS) and UL RS (e.g., SRS) are configured for positioning measurement; otherwise, the UE does not postpone the transition. In another example the UE postpones the transition if the UE is not configured with certain type of RS for positioning measurements; otherwise, the UE does not postpone the transition. In another example the UE postpones the transition if the UE is not configured with UL RS (e.g., SRS) for positioning measurement; otherwise, the UE does not postpone the transition.
   d. Another example of the condition comprising postponing the transition is based on whether the BW of the RS used for positioning measurements is within the BW of the active BWP. In one example the UE postpones the transition if the BW of the RS used for positioning measurements may not be or is not guaranteed to be within the BW after the transition; otherwise, the UE does not postpone the transition.
   e. Another example of the condition comprising postponing the transition upon receiving an indication or message from a network node (e.g., NN1, NN2 etc.). The message allowing the UE to postpone the RRC state transition e.g., until the completion of the ongoing positioning measurement, for certain time period (ΔT), etc.
   f. Another example of the condition comprising postponing the transition is based on number of configured positioning measurements. In one example the UE postpones the transition if the UE is configured to perform more than one positioning measurements (e.g., RSTD and PRS-RSRP, or UE Rx-Tx and PRS-RSRP); otherwise, the UE does not postpone the transition.
   g. Another example of the condition comprising postponing the transition is based on type of the configured positioning method for performing positioning measurements. In one example the UE postpones the transition if the UE is configured with DL-TDOA; otherwise, the UE does not postpone the transition. In another example the UE postpones the transition if the UE is configured with multi-RTT; otherwise, the UE does not postpone the transition.
   h. Another example of the condition comprising postponing the transition is based on whether the UE has or will have valid time advance command (TA) after the transition. In one example the UE postponing the transition if the UE has or will have valid time advance command after the transition; otherwise, the UE does not postpone the transition.
   i. Another example of the condition comprising postponing the transition is based on whether the UE needs time advance command (TA) after the transition. In one example the UE postpones the transition if the UE does not need time advance command after the transition; otherwise, the UE does not postpone the transition.
   j. Another example of the condition for postponing the transition is based on the activity level of RRC1 and/or of RRC2 and/or type of positioning measurement and/or type of RS configured for positioning measurement. In one example the UE may postpone the transition if RRC1 is RRC connected state, and the UE is performing a bidirectional measurement.
   k. Another example of the condition for postponing the transition is based on the extent to which the current measurement is performed until the RRC state transition occurs. This can be expressed in terms of faction of the total measurement period (i.e., period in RRC1) completed and/or number of samples obtained until the RRC state transition is triggered. For example, if the minimum requirements are based on X7 number of samples (e.g., X7=5 samples) under radio side condition (e.g., SINR ≥−6 dB) and UE has already taken X8 number of samples above a threshold (Hx) (where X8<X7 e.g., X8=4 samples and), then the UE may postpone the transition until the time the UE obtains at least the remaining (X7-X8) samples e.g., 1 sample assuming X7=5 and X8=4. Otherwise, if the UE has obtained number of samples below or equal to Hx then the UE may not postpone the transition.
8. UE measurement behavior until certain number of RRC state transitions: In another example of the rule, the UE applies any of the above rules (e.g., any one of the rules #1 to #7) until the number (Nt) of RRC state transitions do not exceed certain threshold (Ht). After Nt exceeding Ht the UE may discard or abandon the measurement. In one example Ht=1. In another example Ht>1 e.g., Ht=3. Ht may be pre-defined or configured by the network node.
9. UE measurement behavior based on configuration message: In another example of the rule, the UE determines its measurement behavior (e.g., any one of the rules #1 to #7 or another rule) based on a configuration message received by the UE from a network node e.g., NN1, NN2, etc. For example, the UE measurement behavior after RRC state transition is controlled or managed by the network e.g., via pre-configured message, flag, timer, etc. Examples of such rules are:
   a. In one example of the rule, NN2 may configure the UE whether the UE can: continue the measurement also in RRC2 after the transition or restart the measurement after the transition to RRC2 or stop/abandon the measurement after the transition to RRC2 or postpone the RRC state transition if the measurement is not completed in RRC1, etc.
   b. In another example of the rule, the UE may receive the message or configured with the measurement behavior in the assistance data containing positioning measurement configuration e.g., PRS configuration. In another example the UE may receive the message or configured with the measurement behavior in a separate configuration message. The UE performs the measurement based on the configured UE measurement behavior.
   c. In another example of the rule, a network node (e.g., NN1, NN2) may configure the UE with the RRC state in which the configured measurements are applicable e.g., whether the configured positioning measurements can be performed only in low activity RRC state or only in high activity RRC state or in any two or more RRC activity states (e.g., in RRC inactive and RRC connected states, or in RRC idle and RRC connected states or in RRC idle and RRC inactive states. The UE performs the measurement when operating in one or more RRC states, in which the configured UE measurements are applicable.
   d. In another example of the rule, the UE may be configured with a flag or an indicator by a network node (e.g., NN1, NN2). The UE is configured with assistance data or measurement configuration for performing the positioning measurements at least during RRC1 i.e., before the RRC state transition. In one example when the flag is set or enabled (e.g., 1) or is configured at the UE then the UE connects to or contact NN2 (e.g., location server, LMF etc.) when RRC state transition occurs. The UE may connect by sending a message to the network node e.g., indicating the RRC state has changed. In one example the UE may receive a message from the network node configuring the UE with the measurement behavior to be applied in RRC2 e.g., whether the UE to continue the measurement, stop the measurement or restart the measurement in RRC2. The UE measures during RRC2 according to the configured measurement behavior. The UE may further receive a new or updated assistance data or measurement configuration for performing the positioning measurements during RRC2 after the RRC state transition. The UE further uses the updated assistance data or measurement configuration for performing the positioning measurements during RRC2. But if the flag is not set (or disabled or not configured) then the UE may consider that the network node may not intend to change the assistance data or configuration after the RRC state transition. In this case the UE may assume that the previously provided assistance data or configuration is still applicable and the UE may continue using it and performing the measurements after the RRC state transition. In one example, the above rule may be applicable for RRC state transition between any RRC states. In another example, the above rule may be applicable for RRC state transition only between specific RRC states. In another example, the above rule may be applicable for RRC state transition only from low activity RRC state to high activity RRC state. In another example, the above rule may be applicable for RRC state transition only from high activity RRC state to low activity RRC state.
   e. In another example of the rule, the UE may be configured with a timer based on pre-defined rule or by a network node (e.g., NN1, NN2). The UE is configured with assistance data or measurement configuration for performing the positioning measurements at least during RRC1 i.e., before the RRC state transition. The UE starts the timer upon receiving assistance data in RRC1 or upon starting the positioning measurements during RRC1. In one example if the timer is running then the UE may also continue the positioning measurements after the RRC state transition i.e., during RRC2. If the timer expires while the UE is performing the positioning measurements during RRC2 then the UE connects to or contact NN2 (e.g., location server, LMF etc.). The UE may connect by sending a message to the network node e.g., indicating the RRC state has changed. In one example the UE may receive a message from the network node configuring the UE with the measurement behavior to be applied in RRC2 e.g., whether the UE to continue the measurement, stop the measurement or restart the measurement in RRC2. The UE measures during RRC2 according to the configured measurement behavior. The UE may further receive a new or updated assistance data or measurement configuration for performing the positioning measurements during RRC2 after the RRC state transition. The UE further uses the updated assistance data or measurement configuration for performing the positioning measurements during RRC2. In one example, the above rule may be applicable for RRC state transition between any RRC states. In another example, the above rule may be applicable for RRC state transition only between specific RRC states. In another example, the above rule may be applicable for RRC state transition only from low activity RRC state to high activity RRC state. In another example, the above rule may be applicable for RRC state transition only from high activity RRC state to low activity RRC state.

Embodiment #2: Method in network node of adapting UE positioning measurement procedure According to a second embodiment, a network node (e.g., NN1, NN2 etc.) determines that the UE is configured to perform one or more positioning measurements while operating in RRC1, and further determines that the UE may transition its RRC state from RRC1 to RRC2. The network node may determine that the UE may perform or is performing or going to perform RRC state transition upon fulfilling one or more conditions. Examples of conditions include, but are not limited to:
Arrival of data in the buffer e.g., for downlink transmission. In this case RRC1 and RRC2 can be low activity and high activity RRC states respectively.
Receiving a message from the UE e.g., for transmitting uplink data. In this case RRC1 and RRC2 can be low activity and high activity RRC states respectively.
After certain inactive time period e.g., after expiry of timer which may have started after no data was received from and/or transmitted to the UE. In this case RRC1 and RRC2 can be high activity and low activity RRC states respectively.

The network node (e.g., NN1, NN2) upon determining that the UE may perform or is performing or going to perform RRC state transition may perform one or more tasks or operations. Examples of such tasks include, but are not limited to:
1. In one set of examples of the tasks, the network node may configure the UE with one or more measurement rules for performing the measurement during which the RRC state transition is triggered from RRC1 to RRC2. For example, the network node may configure the UE to delay or postpone the RRC state from RRC1 to RRC2 e.g., stay in RRC1 until the completion of the ongoing positioning measurement and/or for certain time period (ΔT), etc. In another example the network node may configure the UE to restart, abandon or continue the ongoing positioning measurement after the RRC state transition, etc.
2. In one set of examples of the tasks, the network node (e.g., NN1, NN2, gNB, BS etc.) may configure the UE after the transition with one or more procedures for enabling the UE perform the measurements in RRC2. The procedure may further depend on one or more of: the type of RRC state in RRC2, the type positioning measurement, the type of positioning method etc. Examples of the procedures are: configuring the UE with uplink power control (e.g., when RRC2 is high activity state), configuring the UE with timing advance command (e.g., when RRC2 is any of low and high activity states), configuring the UE with measurement gaps (e.g., when RRC2 is high activity state), configuring the UE with UL RS (e.g., SRS) (e.g., when RRC2 is any of low and high activity states), etc.
3. In another set of examples of the tasks, the network node may configure the UE with one or more triggering conditions or events (e.g., flag and/or a timer) (e.g., NN1, NN2 etc.) e.g., in the assistance data or in a configuration message or another message sent to the UE. Examples of the rules defining the UE behaviour when the one or more triggering conditions are met are described in the UE embodiments above. In some embodiments of the present disclosure, the network node behaviour is as follows:
   a. When the flag is set or configured then upon RRC state transition the UE may connect to and contact the network node (e.g., LMF) e.g., by sending a message. In response the network node may send one or more of: information about UE measurement behaviour in RRC2 (e.g., restart, continue, or abandon the measurement after the transition etc.), updated or new assistance data for continuing measurements after the transition, etc.
   b. The timer may start when the UE receives the message or when the UE starts the positioning measurement in RRC1. If the timer expires after the RRC state transition and the UE has not yet completed the positioning measurement, then the UE may connect to and contact the network node (e.g., LMF) e.g., by sending a message. In response the network node may send one or more of: information about UE measurement behaviour (e.g., restart, continue, or abandon the measurement after the transition etc.) in RRC2, updated or new assistance data for continuing measurements after the transition, etc.

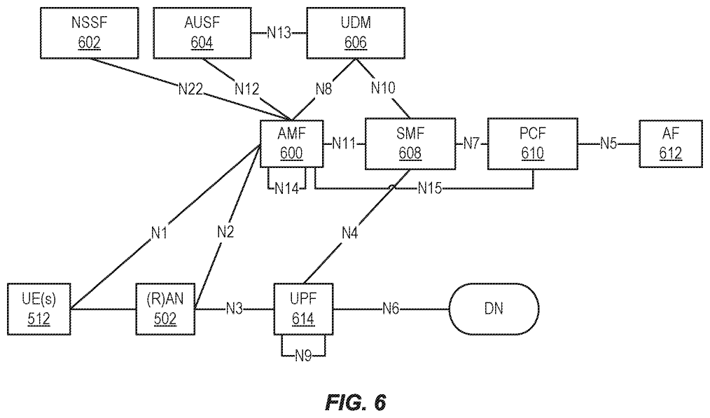

FIG. 6 illustrates a wireless communication system represented as a 5G network architecture composed of core Network Functions (NFs), where interaction between any two NFs is represented by a point-to-point reference point/interface. FIG. 6 can be viewed as one particular implementation of the system 500 of FIG. 5.

Seen from the access side the 5G network architecture shown in FIG. 6 comprises a plurality of UEs 512 connected to either a RAN 502 or an Access Network (AN) as well as an AMF 600. Typically, the R(AN) 502 comprises base stations, e.g., such as eNBs or gNBs or similar. Seen from the core network side, the 5GC NFs shown in FIG. 6 include a NSSF 602, an AUSF 604, a UDM 606, the AMF 600, a SMF 608, a PCF 610, and an Application Function (AF) 612. Reference point representations of the 5G network architecture are used to develop detailed call flows in the normative standardization. The N1 reference point is defined to carry signaling between the UE 512 and AMF 600. The reference points for connecting between the AN 502 and AMF 600 and between the AN 502 and UPF 614 are defined as N2 and N3, respectively. There is a reference point, N11, between the AMF 600 and SMF 608, which implies that the SMF 608 is at least partly controlled by the AMF 600. N4 is used by the SMF 608 and UPF 614 so that the UPF 614 can be set using the control signal generated by the SMF 608, and the UPF 614 can report its state to the SMF 608. N9 is the reference point for the connection between different UPFs 614, and N14 is the reference point connecting between different AMFs 600, respectively. N15 and N7 are defined since the PCF 610 applies policy to the AMF 600 and SMF 608, respectively. N12 is required for the AMF 600 to perform authentication of the UE 512. N8 and N10 are defined because the subscription data of the UE 512 is required for the AMF 600 and SMF 608.

The 5GC network aims at separating UP and CP. The UP carries user traffic while the CP carries signaling in the network. In FIG. 6, the UPF 614 is in the UP and all other NFs, i.e., the AMF 600, SMF 608, PCF 610, AF 612, NSSF 602, AUSF 604, and UDM 606, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 600 and SMF 608 are independent functions in the CP. Separated AMF 600 and SMF 608 allow independent evolution and scaling. Other CP functions like the PCF 610 and AUSF 604 can be separated as shown in FIG. 6. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

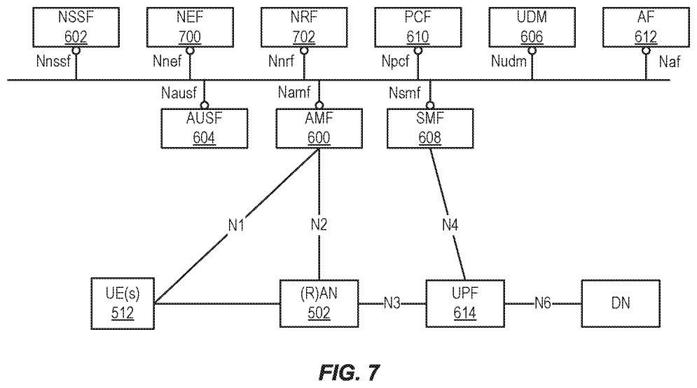

FIG. 7 illustrates a 5G network architecture using service-based interfaces between the NFs in the CP, instead of the point-to-point reference points/interfaces used in the 5G network architecture of FIG. 6. However, the NFs described above with reference to FIG. 6 correspond to the NFs shown in FIG. 7. The service(s) etc. that a NF provides to other authorized NFs can be exposed to the authorized NFs through the service-based interface. In FIG. 7 the service based interfaces are indicated by the letter “N” followed by the name of the NF, e.g., Namf for the service based interface of the AMF 600 and Nsmf for the service based interface of the SMF 608, etc. The NEF 700 and the NRF 702 in FIG. 7 are not shown in FIG. 6 discussed above. However, it should be clarified that all NFs depicted in FIG. 6 can interact with the NEF 700 and the NRF 702 of FIG. 7 as necessary, though not explicitly indicated in FIG. 6.

Some properties of the NFs shown in FIGS. 6 and 7 may be described in the following manner. The AMF 600 provides UE-based authentication, authorization, mobility management, etc. A UE 512 even using multiple access technologies is basically connected to a single AMF 600 because the AMF 600 is independent of the access technologies. The SMF 608 is responsible for session management and allocates Internet Protocol (IP) addresses to UEs. It also selects and controls the UPF 614 for data transfer. If a UE 512 has multiple sessions, different SMFs 608 may be allocated to each session to manage them individually and possibly provide different functionalities per session. The AF 612 provides information on the packet flow to the PCF 610 responsible for policy control in order to support QoS. Based on the information, the PCF 610 determines policies about mobility and session management to make the AMF 600 and SMF 608 operate properly. The AUSF 604 supports authentication function for UEs or similar and thus stores data for authentication of UEs or similar while the UDM 606 stores subscription data of the UE 512. The Data Network (DN), not part of the 5GC network, provides Internet access or operator services and similar.

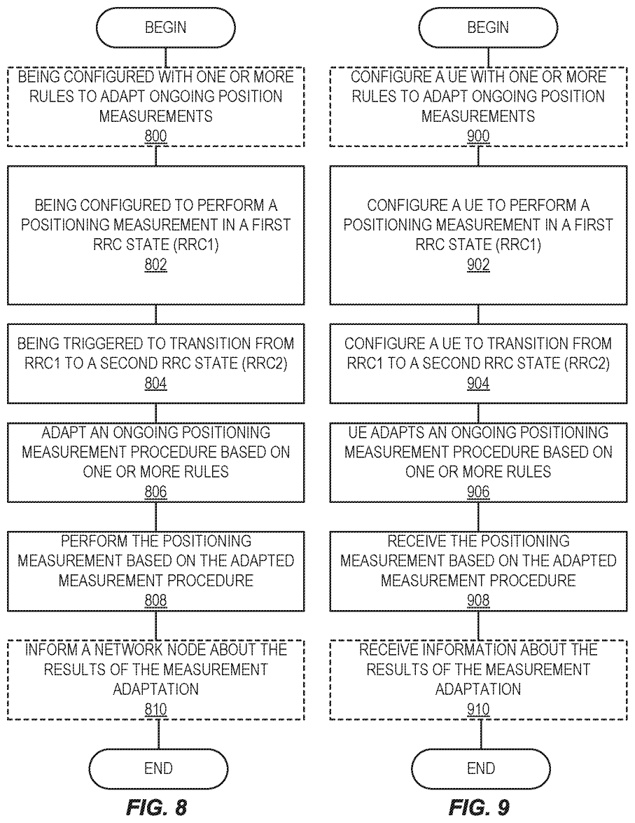

FIG. 8 illustrates a method performed by a UE for performing positioning measurements according to some embodiments of the present disclosure. In some embodiments, the UE is configured with one or more rules by the network node (step 800). In some embodiments, the UE is configured (step 802) to perform a positioning measurement in a RRC1; is triggered (step 804) to transition from RRC1 to a RRC2; in response to the trigger, adapting (step 806) an ongoing positioning measurement procedure based on one or more rules; and performing (step 808) the positioning measurement based on the adapted measurement procedure. In some embodiments, the method optionally includes informing (step 810) a network node about the results of the measurement adaptation.

FIG. 9 illustrates a method performed by a network node for enabling positioning measurements according to some embodiments of the present disclosure. In some embodiments, the method optionally includes configuring (step 900) the UE with one or more rules. In some embodiments, the network node configures (step 902) a UE to perform a positioning measurement in a RRC1; triggers (step 904) the UE to transition from RRC1 to a RRC2; in response to the trigger, the UE adapting (step 906) ongoing positioning measurement procedure based on one or more rules; and receiving (step 908) the positioning measurement based on the adapted measurement procedure. In some embodiments, the method optionally includes receiving (step 910) information about the results of the measurement adaptation.

An NF may be implemented either as a network element on a dedicated hardware, as a software instance running on a dedicated hardware, or as a virtualized function instantiated on an appropriate platform, e.g., a cloud infrastructure.

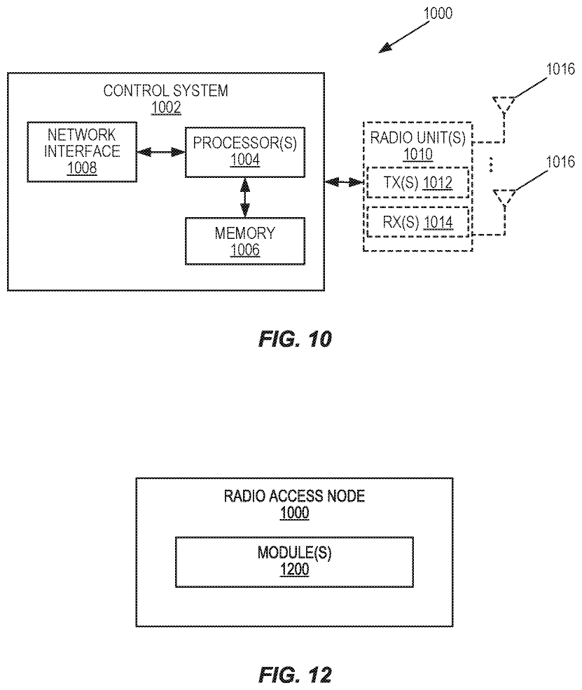

FIG. 10 is a schematic block diagram of a radio access node 1000 according to some embodiments of the present disclosure. Optional features are represented by dashed boxes. The radio access node 1000 may be, for example, a base station QQ102 or QQ106 or a network node that implements all or part of the functionality of the base station QQ102 or gNB described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

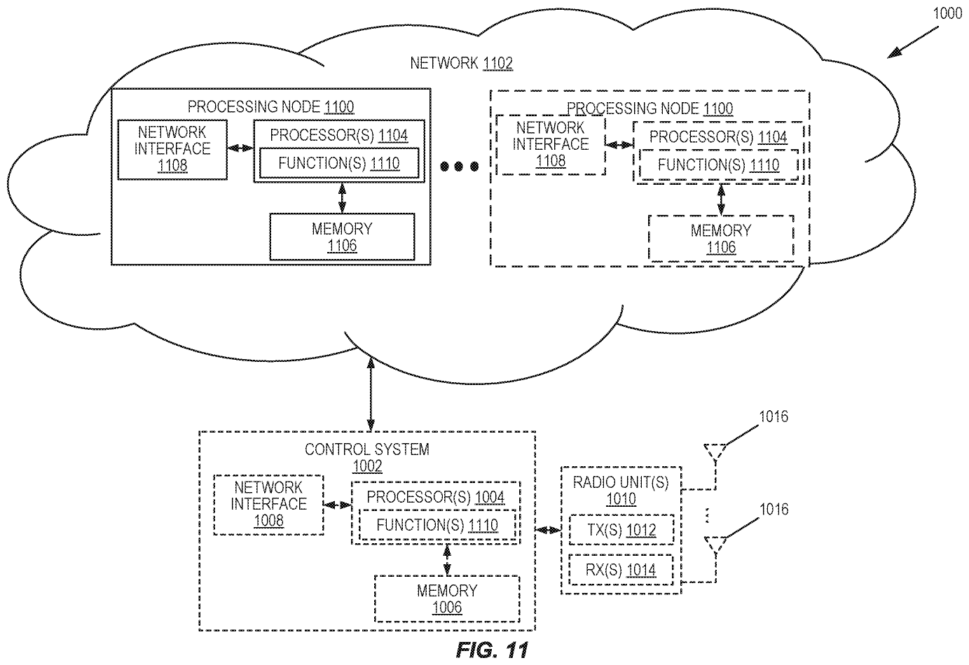

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes. As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

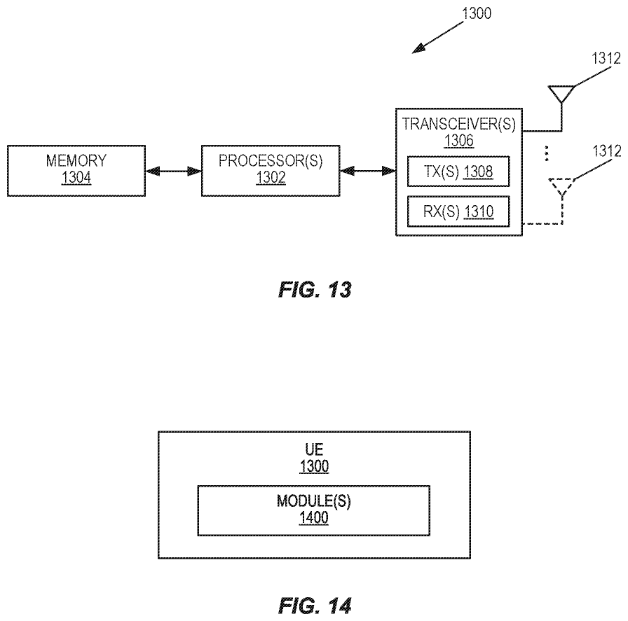

FIG. 13 is a schematic block diagram of a wireless communication device 1300 according to some embodiments of the present disclosure. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided.

In some embodiments, a carrier comprising the aforementioned computer program product is provided. The carrier is one of an electronic signal, an optical signal, a radio signal, or a computer readable storage medium (e.g., a non-transitory computer readable medium such as memory).

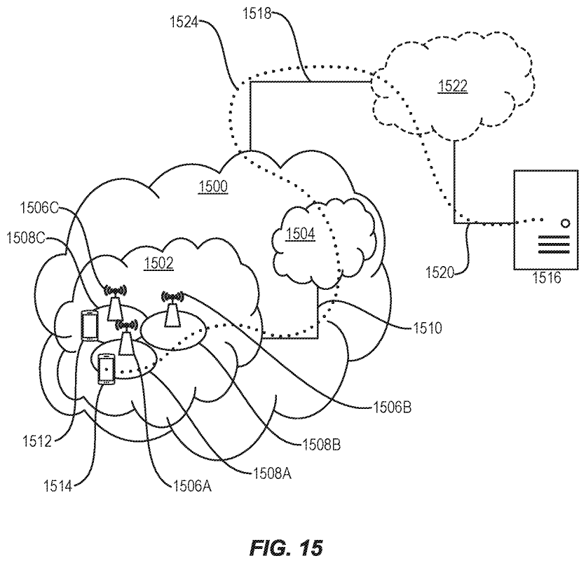

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein. With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown). The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

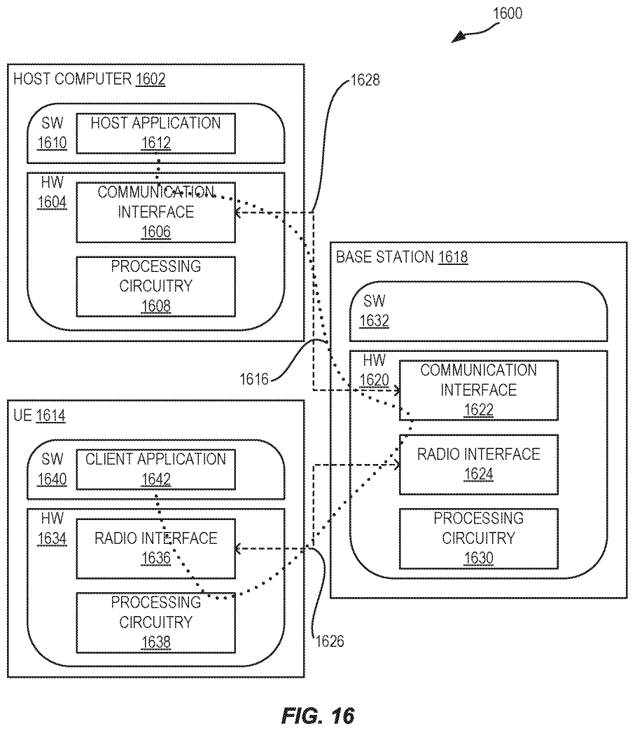

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer's 1602 measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

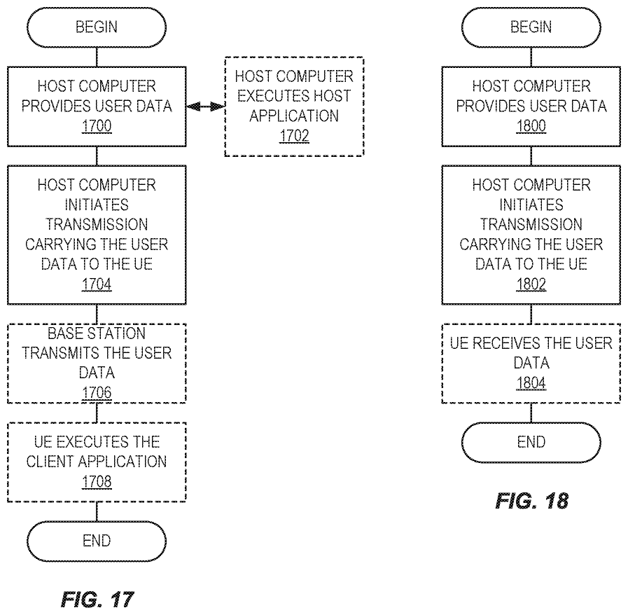

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

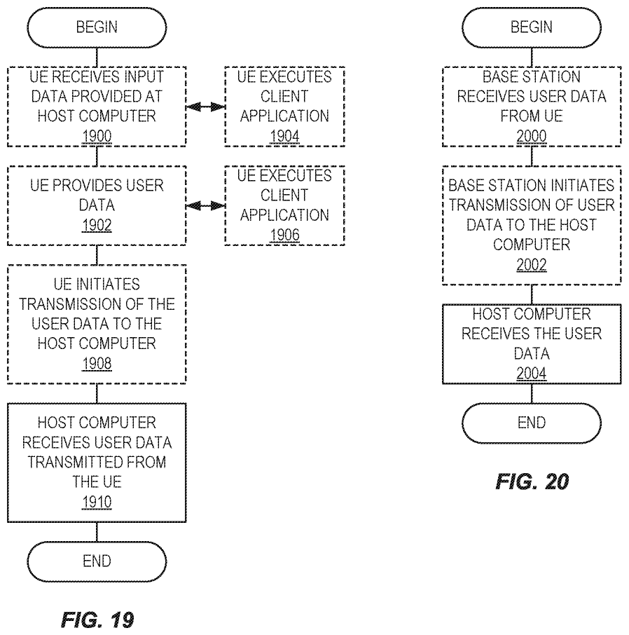

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally, or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Embodiment 1: A method performed by a user equipment for performing positioning measurements, the method comprising one or more of: a. being configured to perform a positioning measurement in a first Radio Resource Control, RRC, state (RRC1); b. being triggered to transition from RRC1 to a second RRC state (RRC2); and c. in response to the trigger, adapting an ongoing positioning measurement procedure based on one or more rules; d. performing the positioning measurement based on the adapted measurement procedure.
Embodiment 2: The method of Embodiment 1 further comprising informing a network node about the results of the measurement adaptation.
Embodiment 3: The method of any of Embodiments 1-2 wherein the one or more rules are pre-defined and/or configured by the network node.
Embodiment 4: The method of any of Embodiments 1-3 wherein the network node is a base station or a positioning node.
Embodiment 5: The method of any of Embodiments 1-4 wherein the one or more rules comprise one or more of: a. continuing the ongoing positioning measurement in RRC1 after the transition to RRC2; b. stopping the ongoing positioning measurement after the transition to RRC2 regardless of whether it is completed or not; c. abandoning or discarding the ongoing positioning measurement done in RRC1, and restarting the ongoing positioning measurement after the transition to RRC2; d. postponing or delaying the RRC state transition e.g. delaying until completion of the ongoing positioning measurement; e. not performing the RRC state transition e.g. until one or more condition is met; f. performing any one or more of the above actions or applying one or more of the above rules depending on a number of transitions (Nt) between RRC1 and RRC2; g. informing the network node (e.g., Location Management Function, LMF) when the one or more conditions are met that the RRC state transition has occurred; and h. receiving further information from the network node regarding positioning measurement behavior after the RRC state transition and performing the positioning measurement based on configured behavior.
Embodiment 6: The method of Embodiment 5 wherein the conditions comprise one or more of: the RRC state transition, expiry of a timer, which is set upon receiving assistance data or starting the measurements (e.g., during RRC1).
Embodiment 7: The method of Embodiment 5 wherein the parameter Nt can be pre-defined or configured by the network node.
Embodiment 8: The method of any of the previous Embodiments, further comprising: providing user data; and forwarding the user data to a host via the transmission to the network node.
Embodiment 9: A method performed by a network node for enabling positioning measurements, the method comprising one or more of: a. configuring a user equipment to perform a positioning measurement in a first Radio Resource Control, RRC, state (RRC1); b. triggering the user equipment to transition from RRC1 to a second RRC state (RRC2); c. configuring the user equipment with one or more rules; d. in response to the trigger, the user equipment adapting ongoing positioning measurement procedure based on the one or more rules; and e. performing the positioning measurement based on the adapted measurement procedure.
Embodiment 10: The method of Embodiment 9 further comprising receiving, from the user equipment, information about the results of the measurement adaptation.
Embodiment 11: The method of any of Embodiments 9-10 wherein the network node is a base station or a positioning node.
Embodiment 12: The method of any of Embodiments 9-11 wherein the one or more rules comprise one or more of: a. continuing the ongoing positioning measurement in RRC1 after the transition to RRC2; b. stopping the ongoing positioning measurement after the transition to RRC2 regardless of whether it is completed or not; c. abandoning or discarding the ongoing positioning measurement done in RRC1, and restarting the ongoing positioning measurement after the transition to RRC2; d. postponing or delaying the RRC state transition e.g. delaying until completion of the ongoing positioning measurement; e. not performing the RRC state transition e.g. until one or more condition is met; f. performing any one or more of the above actions or applying one or more of the above rules depending on a number of transitions (Nt) between RRC1 and RRC2; g. informing the network node (e.g., Location Management Function, LMF) when the one or more conditions are met that RRC state transition has occurred; and h. receiving further information from the network node regarding positioning measurement behavior after the RRC state transition and performing the positioning measurement based on configured behavior.
Embodiment 13: The method of Embodiment 12 wherein the conditions comprise one or more of: the RRC state transition, expiry of a timer, which is set upon receiving assistance data or starting the measurements (e.g., during RRC1).
Embodiment 14: The method of Embodiment 12 wherein the parameter Nt can be pre-defined or configured by the network node.
Embodiment 15: The method of any of the previous Embodiments, further comprising: obtaining user data; and forwarding the user data to a host or a user equipment.
Embodiment 16: A user equipment for performing positioning measurements, comprising: processing circuitry configured to perform any of the steps of any of Embodiments 1-8; and power supply circuitry configured to supply power to the processing circuitry.
Embodiment 17: A network node for enabling positioning measurements, the network node comprising: processing circuitry configured to perform any of the steps of any of Embodiments 9-15; power supply circuitry configured to supply power to the processing circuitry.
Embodiment 18: A user equipment (UE) for performing positioning measurements, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Embodiments 1-8; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 19: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of Embodiments 1-8 to receive the user data from the host.
Embodiment 20: The host of the previous Embodiment, wherein the cellular network further includes a network node configured to communicate with the UE to transmit the user data to the UE from the host.
Embodiment 21: The host of the previous 2 Embodiments, wherein: the processing circuitry of the host is configured to execute a host application, thereby providing the user data; and the host application is configured to interact with a client application executing on the UE, the client application being associated with the host application.
Embodiment 22: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of Embodiments 1-8 to receive the user data from the host.
Embodiment 23: The method of the previous Embodiment, further comprising: at the host, executing a host application associated with a client application executing on the UE to receive the user data from the UE.
Embodiment 24: The method of the previous Embodiment, further comprising: at the host, transmitting input data to the client application executing on the UE, the input data being provided by executing the host application, wherein the user data is provided by the client application in response to the input data from the host application.
Embodiment 25: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of Embodiments 1-8 to transmit the user data to the host.
Embodiment 26: The host of the previous Embodiment, wherein the cellular network further includes a network node configured to communicate with the UE to transmit the user data from the UE to the host.
Embodiment 27: The host of the previous 2 Embodiments, wherein: the processing circuitry of the host is configured to execute a host application, thereby providing the user data; and the host application is configured to interact with a client application executing on the UE, the client application being associated with the host application.
Embodiment 28: A method implemented by a host configured to operate in a communication system that further includes a network node and a user equipment (UE), the method comprising: at the host, receiving user data transmitted to the host via the network node by the UE, wherein the UE performs any of the steps of any of Embodiments 1-8 to transmit the user data to the host.
Embodiment 29: The method of the previous Embodiment, further comprising: at the host, executing a host application associated with a client application executing on the UE to receive the user data from the UE.
Embodiment 30: The method of the previous Embodiment, further comprising: at the host, transmitting input data to the client application executing on the UE, the input data being provided by executing the host application, wherein the user data is provided by the client application in response to the input data from the host application.
Embodiment 31: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of Embodiments 9-15 to transmit the user data from the host to the UE.
Embodiment 32: The host of the previous Embodiment, wherein: the processing circuitry of the host is configured to execute a host application that provides the user data; and the UE comprises processing circuitry configured to execute a client application associated with the host application to receive the transmission of user data from the host.
Embodiment 33: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of Embodiments 9-15 to transmit the user data from the host to the UE. Embodiment 34: The method of the previous Embodiment, further comprising, at the network node, transmitting the user data provided by the host for the UE.
Embodiment 35: The method of any of the previous 2 Embodiments, wherein the user data is provided at the host by executing a host application that interacts with a client application executing on the UE, the client application being associated with the host application.
Embodiment 36: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of Embodiments 9-15 to transmit the user data from the host to the UE.
Embodiment 37: The communication system of the previous Embodiment, further comprising: the network node; and/or the user equipment.
Embodiment 38: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of Embodiments 9-15 to receive the user data from a user equipment (UE) for the host.
Embodiment 39: The host of the previous 2 Embodiments, wherein: the processing circuitry of the host is configured to execute a host application, thereby providing the user data; and the host application is configured to interact with a client application executing on the UE, the client application being associated with the host application.
Embodiment 40: The host of the any of the previous 2 Embodiments, wherein the initiating receipt of the user data comprises requesting the user data.
Embodiment 41: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of Embodiments 9-15 to receive the user data from the UE for the host.
Embodiment 42: The method of the previous Embodiment, further comprising at the network node, transmitting the received user data to the host.

Those skilled in the art will recognize improvements and modifications to the embodiments of the present disclosure. All such improvements and modifications are considered within the scope of the concepts disclosed herein.

### Discussion on RRC Inactive Mode Positioning

### 1 Introduction

Inactive mode positioning is currently being discussed in RAN2. There are several factors that still needs to be considered. We underline and discuss some of these aspects in this paper.
Segmentation
TA Validation
State Transition Handling
Aperiodic UL SRS in Inactive Mode
Obtaining posSIB in Inactive Mode.
Assistance Data for CG-SDT

### 2 Discussion

### 2.1 Segmentation

Current LPP segmentation defined in the specification is mainly because of NAS transport layer constraints that is put on the LPP layer. The intention is not to segment so that the lower layers can accommodate the data. The lower layer constrains are handled in RLC with RLC segmentation but not by LPP.

Hence, LPP segmentation to fit the content using SDT procedure is against the normal mode of operation. NW may have to configure several small chunks of resources which may also lead to resource fragmentation and not a good utilization. It may simplify if UE transits to connected mode.
LPP segmentation to fit the content for transmission using SDT procedure is against the modus operandi.

When the LPP content comes to lower layer then the content should be checked against the configured DVT. If the LPP data size is lower than the DVT; and if UL grant is not adequate there can be RLC segmentation. In such cases, NW may provide resources for subsequent transmission using SDT procedure.

If the size of UL data is bigger than that of the UL grant, UE can send the BSR in the first UL SDT which indicates there is more data needed to be transmitted, and then the network will assign the subsequent UL grant after receiving the first UL SDT.
LPP Segmentation to fit the content for transmission using SDT procedure is not allowed.
UE sends the BSR in the first UL SDT which indicates there is more data needed to be transmitted provided the size of UL data is bigger than that of the UL grant

### 2.2 TA Validation

TA may remain constant for stationary device. For these devices as well, they are required to validate the TA. Positioning involves UE in motion. The TA would be valid for very short time. During connected mode there would be several TA adjustments to synchronize the UE and perform power control and minimize interference. How would TA be adjusted while UE is in motion should be investigated before simply adopting a procedure which has been primarily designed for stationary UE; using PUR for example.

RAN1 should do such investigation or RAN2 should limit the positioning use case for stationary UEs only.
Send a LS to RAN1 to investigate how TA can be adjusted in inactive mode or limit the use case such that inactive mode positioning is valid only for UEs which are fixed.

### 2.3 State Transition Handling

UE behaviour during State Transition while configured to perform positioning measurements or to transmit UL SRS needs to be discussed. For example; for UL SRS Tx in Inactive mode, only open loop power control is allowed while in connected mode closed loop power control also would be operational. Can UE continue UL SRS Tx that was configured for inactive mode when UE switches from Inactive mode to Connected mode for some other reason such as voice call, being paged. For example, can UE continue the ongoing measurements in the new RRC state, or should it be discarded? Should gNB release inactive mode configuration and provide new configuration or can UE continue? If gNB releases and provides new configuration, will there be any notification to LMF so that LMF can inform other listening (gNBs/TRPs) that current configuration is aborted, and new configuration is applied. In such case, LMF may need to be notified about the failure reason “change of UE RRC states”.

But important aspect is whether UE can continue to transmit UL SRS while there is state transition using previous inactive mode configurations/resources? This should be a question to RAN1/RAN4.
RAN2 to send a LS to RAN1/RAN4 asking whether UL SRS Tx can be continued or aborted when UE switches from Inactive to connected mode.

Similarly, when UE has been configured to perform DL-TDOA measurements in inactive mode and UE switches to connected mode for any other reasons such as voice call; can UE continue performing the measurements in connected mode. Gaps are needs for positioning measurements in connected mode. Therefore, they will be additional delay in configuring the gaps. Impact of this additional delay on the accuracy can better be assessed by RAN4. Should it stay in connected mode until the measurements are over or should it switch to inactive mode and continue (assuming voice session is released)? Would the measurements performed in various states be valid?

RAN2 should check with RAN4 on the measurement accuracy and requirements and whether combining measurements performed at different RRC states does not pose any accuracy limitations.
RAN2 to send a LS to RAN4 asking UE measurements validity when UE has performed measurements in different RRC states. Should the previous measurements be discarded, or can it be continued after state transition.

### 2.4 Aperiodic UL SRS Tx

Configuring UTDOA requires lot of signalling. Lot of preparation needs to be done before hand. Hence it may not be justified that for a single shot measurement so much of preparation is done. As such during periodic or SP UL SRS transmission; to boost current UL SRS Tx; aperiodic Tx may be desired. However, for inactive mode as NW cannot reach to the UE (no MT-SDT procedure or only by means of paging); thus, it does not justify transmitting aperiodic UL SRS
Aperiodic UL SRS Transmission in Inactive mode is not supported.

### 2.5 SDT for posSIB Retrieval

One important use case that SDT should be used is obtaining posSIBs in Inactive mode using SDT framework. As discussed in Rel-16, there are several posSIBs with varying nature; where some are static and large. Broadcasting these would consume lot of radio resource and power and the use of broadcast for these sorts of posSIBs when there are few users is meaningless.

The changes needed to support this is minor. UE just needs to insert the SIB request as part of RRC Resume Request message for example for the msg3 case.

The msg3 would then comprise of
MAC CE+RRC Resume Request+RRC System Info Request Msg
Support of posSIB retrieval using SDT in Inactive mode

### 2.6 Dedicated Delivery

As discussed during Rel-16, in order to avoid resource allocation of any S1 Window for posSIBs which would be provided via unicast, a unicast tag should be provided. This will also allow UE to save power by not having to monitor to broadcast as NW will anyway provide by means of unicast.

The impacts of introducing a dedicated delivery tag is small whereas the benefits are large.
NW does not need to reserve the S1 resource which are to be sent via dedicated signaling. This allows more resources for S1 that needs to be scheduled
UE can save power by not having to listen to broadcast as it knows NW will send only via dedicated signaling such as DL SDT or RRCReconfiguration message.

PosSchedulingInfo-r16 ::= SEQUENCE

| | | |
|---|---|---|
| offsetToSI-Used-r16 | ENUMERATED {true} | OPTIONAL, - |

- Need R

| | |
|---|---|
| posSI-Periodicity-r16 | ENUMERATED {rf8, rf16, rf32, rf64, rf128, rf256, rf512}, |
| posSI-BroadcastStatus-r16 | ENUMERATED {broadcasting, notBroadcasting}, |
| posSIB-MappingInfo-r16 | PosSIB-MappingInfo-r16, |

```
  ...,
    [[
```

| | |
|---|---|
| posSI-DedicatedDelivery-r17 | ENUMERATED {true} |

```
    OPTIONAL -Need R,
    ]]
}
```

posSI-DedicatedDelivery

Indicates if the S1 message is provided by means of only dedicated delivery. The field posSI-BroadcastStatus is ignored when posSI-DedicatedDelivery is set to true.

### 2.7 Assistance Data for GG-SDT

gNB needs to configure CG-SDT resource. It may be unpredictable as what sort of data size that UE needs to convey. Depending upon propagation environment i.e. LOS/NLOS conditions (multipath); the measurement size may vary. Further, the AD configuration as how many TRPs the UE is supposed to measure would also influence. As such, the UE may not determine the needed UL grant size. The main information needed by gNB is some sort of QoS for Positioning to dimension the CG-SDT resource. The deferred positioning procedure periodicity, measurement periodicity, response Time, accuracy requirements etc. These information about positioning requirement characteristic can be conveyed from LMF.
UE cannot judge the positioning data size in advance. It would simply increase the Uu load. Instead some indication can be sent via LMF which gNB can use to dimension the CG-SDT resources.

One way to enhance the CG-SDT would be that LMF informs the needed positioning QoS in terms of latency and accuracy. The SA2 specification broadly categorizes the latency requirements in three categories: no delay, low delay and delay tolerant [TS 23.273].

A broad level accuracy categorization can be provided by LMF in terms of positioning accuracy. If the requirement in terms of accuracy is high, it is expected that the UE has to provide large data, similarly if the accuracy requirement is low, the resulting measurement report from UE does not need to be large.

The positioning QoS information from LMF to gNB can help gNB to decide what sort of UL grant be required by the UE; whether a large UL grant with small periodicity or small UL grant with large periodicity is enough.

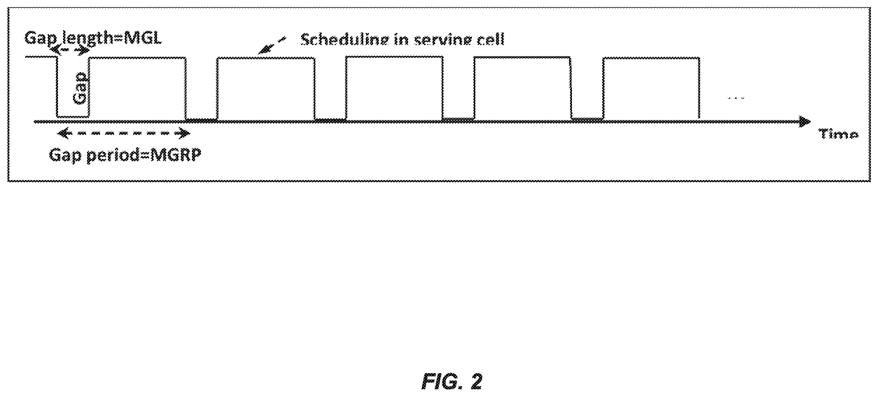

FIG. 2: gNB Allocates UL grant periodicity dependent upon the QoS latency (short or large periodicity)
If gNB is aware of positioning requirements, it can allocate the resources efficiently.
LMF provides the configured measurement periodicity and positioning requirements to gNB.
RAN2 to send an LS to RAN3 to include additional information of positioning requirements in NRPPa

### Conclusion

In the previous sections we made the following observations:
Observation 1 LPP segmentation to fit the content for transmission using SDT procedure is against the modus operandi.
Observation 2 UE cannot judge the positioning data size in advance. It would simply increase the Uu load. Instead some indication can be sent via LMF which gNB can use to dimension the CG-SDT resources.
Observation 3 If gNB is aware of positioning requirements, it can allocate the resources efficiently.

Based on the discussion in the previous sections we propose the following:
Proposal 1 LPP Segmentation to fit the content for transmission using SDT procedure is not allowed.
Proposal 2 UE sends the BSR in the first UL SDT which indicates there is more data needed to be transmitted provided the size of UL data is bigger than that of the UL grant
Proposal 3 Send a LS to RAN1 to investigate how TA can be adjusted in inactive mode or limit the use case such that inactive mode positioning is valid only for UEs which are fixed.
Proposal 4 RAN2 to send a LS to RAN1/RAN4 asking whether UL SRS Tx can be continued or aborted when UE switches from Inactive to connected mode.
Proposal 5 RAN2 to send a LS to RAN4 asking UE measurements validity when UE has performed measurements in different RRC states. Should the previous measurements be discarded, or can it be continued after state transition.
Proposal 6 Aperiodic UL SRS Transmission in Inactive mode is not supported.
Proposal 7 Support of posSIB retrieval using SDT in Inactive mode
Proposal 8 LMF provides the configured measurement periodicity and positioning requirements to gNB.
Proposal 9 RAN2 to send an LS to RAN3 to include additional information of positioning requirements in NRPPa

### PRS Measurement Requirements in RRC Inactive State

### 1. INTRODUCTION

In the last RAN4 meeting a WF on RRM requirements for positioning enhancement was approved [1]. In the approved WF the positioning measurement requirements in RRC inactive state were initially analyzed. There were few high-level agreements as shown below [1]:
At least UE RRM requirements for DL RSTD and DL PRS-RSRP measurements in RRC-INACTIVE state are specified.
RAN4 shall define inactive state positioning measurements for FR1 and FR2.
MG is not to be considered in the measurement period requirements in RRC_INACTIVE state.
Use the framework or formula of Rel-16 PRS_RSRP measurement period as a baseline to derive the inactive state PRS-RSRP measurement period.
FFS: RAN4 to take connected mode measurement performance requirements for DL RSTD and PRS-RSRP as baseline for inactive state measurement performance requirements.
RAN4 wait for the outcomes of other WGs and define the reporting requirements based on the conclusions.
RAN4 to discuss impact of positioning measurements on RRC_INACTIVE state functions.

In this paper the above open issues identified in the WF are further analyzed.

### 2. TYPE OF MEASUREMENTS IN RRC_INACTIVE STATE

RAN4 has agreed that the requirements for at least DL RSTD and DL PRS-RSRP measurements in RRC-INACTIVE state will be specified.

In their LS, RAN1 has agreed that semi-persistent SRS for positioning by RRC_INACTIVE UEs is also feasible [2]:

### Agreement:

Send LS to RAN2 with the outcome of RAN1 discussion on types of SRS for positioning to be supported by UEs in RRC_INACTIVE state
From RAN1 perspective, support of semi-persistent SRS for positioning by RRC_INACTIVE UEs is feasible.
It is up to RAN2 to confirm support of semi-persistent SRS for positioning by RRC_INACTIVE UEs and determine necessary signalling details

The SRS is used for UE Rx-Tx time difference. However, until now there is no formal agreement in RAN1 regarding UE Rx-Tx time difference measurements in RRC-INACTIVE state. Therefore, RAN4 should wait for further RAN1 and RAN2 agreements regarding the use of UE Rx-Tx time difference in RRC inactive state.

### 3. MEASUREMENT REQUIREMENTS IN RRC_INACTIVE STATE

It was agreed that measurement gaps will not be considered for DL RSTD and PRS-RSRP measurements in RRC_INACTIVE state.

Since the gaps are used therefore, the PRS availability should be based on the PRS resource periodicity.

The latency reduction for PRS measurements is part of Rel-17 positioning enhancement. Positioning measurement requirements in RRC_INACTIVE state are also being specified in Rel-17. Therefore, we propose not to include latency reduction in to consider in the measurement requirements in RRC_INACTIVE. Therefore, the number of samples (Nsample) is the same as in Rel-16 i.e. 4 samples.

Furthermore, frequent PRS measurements in RRC inactive state will significantly drain the UE battery power. Therefore, in RRC inactive state the UE we suggest to define PRS measurements for relatively longer PRS resource periodicity e.g. 160 ms or longer.

Scaling the measurement period with DRX cycle especially for longer DRX will lead to very long measurement period rendering the PRS measurements less useful for positioning. Instead, the measurement period can be scaled with the number of carriers configured for all the measurements in RRC inactive state.

The side conditions in terms of PRS Ês/Iot under which the PRS measurements are applicable should be the same as in RRC connected state.

Based on the above arguments the measurement period of RSTD and PRS-RSRP in RRC inactive state can be expressed as follows:

$${T}_{RSTD , i} = ( {K}_{carrier} * {N}_{RxBeam , i} * ⌈ \frac{{N}_{PRS , i}^{slot}}{{N}^{′}} ⌉ ⌈ \frac{{L}_{PRS , i}}{N} ⌉ * {N}_{sample} - 1 ) * {T}_{effect , i} + {T}_{last , i} ,$$

Where:
K_{carrier} is the total number of the configured positioning frequency layers, NR inter-frequency carriers for mobility measurements, inter-RAT carriers for mobility measurements, NR inter-frequency carriers for CA measurements and inter-RAT carriers for CA measurements.
L_{PRS,i} is the time duration of available PRS resources in the positioning frequency layer i, to be measured during T_{PRS,i}

$${T}_{effect , i} = ⌈ \frac{{T}_{i}}{{T}_{PRS , i}} ⌉ * {T}_{PRS , i}$$

T_{PRS,i}≥160 ms
Nₛₐₘₚₗₑ=4
Other parameters are the same as in the existing requirements for RSTD and PRS-RSRP.

### 4. PRS MEASUREMENT REQUIREMENTS UNDER RELAXED MEASUREMENT CRITERIA

The UE can also be configured with one or more relaxed measurements on mobility related carriers in RRC_INACTIVE state. It is possible that the mobility related carrier is also a positioning frequency layer i.e. with same NR ARFCN. Even if the UE meets relaxed measurement criterion for a mobility carrier which is also a PFL, the UE should not be allowed to relax any PRS measurements on that PFL carrier.

### 5. APPLICABILITY OF MEASUREMENT REQUIREMENTS UNDER PRS COLLISIONS

RAN1 has made the following agreements regarding the collision/priority handling of the PRS with respect to other signals in RRC_INACTIVE state [3]:

### Agreement:

From RAN1 perspective, in RRC_INACTIVE state, reception of DL PRS has lower priority than other DL signals/channels (SSB, SIB1, CORESET0, MSG2/MSGB, paging, DL SDT)
   FFS how to determine conflicts in DL PRS and other DL signals/channels reception by UE
   FFS how to handle retuning time for the case when DL PRS and other DL signals/channels are allocated in different BW and/or have the same or different SCS as initial DL BWP.
Send LS to RAN4 (cc RAN2) and ask if there is any feedback

The above agreements would imply that the UE may have to drop the PRS if the PRS symbol carriers any of these signals/channels: SSB, SIB1, CORESET0, MSG2/MSGB, paging, DL SDT. RAN4 can address the PRS dropping due to the above priority rule using the following existing requirement rule in RRC connected state:
The RSTD and PRS-RSRP measurement requirements in RRC_INACTIVE state shall apply, provided that no PRS symbols are dropped during their respective measurement periods due to the collisions with other signals; otherwise, a longer measurement period may be used.

### 6. MEASUREMENT REQUIREMENTS UNDER RRC STATE TRANSITION

A Rel-17 UE supporting PRS measurements (assuming supporting in both RRC_INACTIVE and RRC_CONNECTED states) configured with PRS measurements may change its RRRC state any time. The LMF is not aware of the UE RRC state any time. There are following two scenarios:
RRC state transition scenario #1: The UE configured with and while performing PRS measurements in RRC_INACTIVE state may change its RRC state from RRC_INACTIVE state to RRC_CONNECTED state.
RRC state transition scenario #2: The UE configured with and while performing PRS measurements in RRC_CONNECTED state may change its RRC state from RRC_CONNECTED state to RRC_INACTIVE state.

In the RRC state transition scenario #1, the UE needs measurement gaps for performing the PRS measurements in RRC_CONNECTED state. RAN4 is also expected to develop PRS measurements requirements without gaps in Rel-17. In our view at least the case when gaps are needed should be considered when the UE changes the RRC states. In this case, since UE will request the gaps causing additional delay, so it is better that the UE discards the old samples in RRC_INACTIVE and restarts the positioning measurements after the RRC state transition to RRC_CONNECTED. For gapless measurement case RAN4 can further discuss the UE behaviour when the work on the gapless measurements has progress. But in our view if gaps are not needed then the UE can continue the positioning measurements after the RRC state transition to RRC_CONNECTED state.

In the RRC state transition scenario #2, the UE does not need any measurement gap for performing the PRS measurements after entering in RRC_INACTIVE state. In this case, the UE should be able to continue the positioning measurements after the RRC state transition to RRC_INACTIVE. We do not see any reason to restart the measurement in RRC_INACTIVE state.

In both scenarios, the PRS measurement period can be the longest of the PRS measurement periods in RRC_INACTIVE and RRC_CONNECTED states.

### 7. SUMMARY

The following are the observations and proposals based on the analysis provided in this paper:

### Type of Positioning Measurements in RRC_INACTIVE:

Observation #1: Semi-persistent SRS for positioning by RRC_INACTIVE UEs is feasible; but no formal agreement in RAN1 yet regarding the use of Rx-Tx time difference measurement in RRC inactive state.
Proposal #1: RAN4 to wait for further agreements in RAN1 and RAN2 (if any) regarding Rx-Tx time difference measurement applicability in RRC inactive state.

### Measurement Requirements in RRC_INACTIVE:

Observation #2: Too frequent PRS measurements in RRC inactive state will significantly drain the UE battery power.
Observation #3: Scaling the measurement period with DRX cycle especially for longer DRX will lead to very long measurement period rendering the PRS measurements less useful for positioning.
Proposal #2: Do not consider latency reduction in RRC_INACTIVE state in Rel-17.
Proposal #3: To save UE power consumption define RSTD and PRS-RSRP measurement requirements in RRC_INACTIVE state for T_{PRS}≥160 ms.
Proposal #4: To save UE power consumption, the measurement period of RSTD and PRS-RSRP measurements scale with the total number of configured carriers (K_{carriers}) for positioning measurements, mobility measurements and CA measurements.
Proposal #5: Existing side conditions in terms of PRS Ês/Iot under which the PRS measurements are applicable are reused i.e. following applies for PRS measurements in RRC_INACTIVE state:
   For RSTD: PRS Ês/Iot ≥−6 dB for reference cell and PRS Ês/Iot ≥−13 dB for neighbor cell
   For PRS-RSRP: PRS Ês/Iot ≥−3 dB and PRS Ês/Iot ≥−13 dB
Proposal #6: RSTD measurement period in RRC_INACTIVE state is expressed as follows:

$${T}_{RSTD , i} = ( {K}_{carrier} * {N}_{RxBeam , i} * ⌈ \frac{{N}_{PRS , i}^{slot}}{{N}^{′}} ⌉ ⌈ \frac{{L}_{PRS , i}}{N} ⌉ * {N}_{sample} - 1 ) * {T}_{effect , i} + {T}_{last , i} ,$$

Where:
K_{carrier} is the total number of the configured positioning frequency layers, NR inter-frequency carriers for mobility measurements, inter-RAT carriers for mobility measurements, NR inter-frequency carriers for CA measurements and inter-RAT carriers for CA measurements.
L_{PRS,i} is the time duration of available PRS resources in the positioning frequency layer i, to be measured during T_{PRS,i}

$${T}_{effect , i} = ⌈ \frac{{T}_{i}}{{T}_{PRS , i}} ⌉ * {T}_{PRS , i}$$

T_{PRS,i}≥160 ms
Nₛₐₘₚₗₑ=4
Other parameters are the same as in the existing RSTD and PRS-RSRP requirements in RRC connected state.

### PRS Measurement Requirements Under Relaxed Measurement Criteria:

Observation #4: Mobility related carrier configured with one or more relaxed measurement criteria, may also be configured as a positioning frequency layer (PFL) in RRC_INACTIVE state i.e. with same NR ARFCN.
Proposal #7: The UE is not be allowed to relax any PRS measurement on a PFL, which is also configured as a carrier frequency for mobility measurements and meet any relaxed measurement criterion.

### Applicability of Measurement Requirements Under PRS Collisions:

Observation #5: In RRC_INACTIVE state, reception of DL PRS has lower priority than other DL signals/channels (SSB, SIB1, CORESET0, MSG2/MSGB, paging, DL SDT.
Proposal #8: To address the PRS dropping due to the priority between PRS and other signals/channels the following existing requirement rule also applies in RRC_INACTIVE state:
   The RSTD and PRS-RSRP measurement requirements in RRC_INACTIVE state shall apply, provided that no PRS symbols are dropped during their respective measurement periods due to the collisions with other signals; otherwise, a longer measurement period may be used.

### Measurement Requirements Under RRC State Transition:

Observation #6: UE supporting PRS measurements (assuming supporting in both RRC_INACTIVE and RRC_CONNECTED states) configured with PRS measurements may change its RRRC state any time.
Proposal #9: UE configured with and performing PRS measurement in RRC_INACTIVE state shall restart the PRS measurements after transition to RRC_CONNECTED state if the UE needs measurement gaps for the PRS measurement in the RRC_CONNECTED state.
Proposal #10: UE configured with and performing PRS measurement in RRC_INACTIVE state shall continue the PRS measurements after transition to RRC_CONNECTED state if the UE does not need measurement gaps for the PRS measurement in the RRC_CONNECTED state.
Proposal #11: UE configured with and performing PRS measurement in RRC_CONNECTED state shall continue the PRS measurements after transition to RRC_INACTIVE state.
Proposal #12: In proposals #9, #10 and #12, the PRS measurement period shall be the longest of the PRS measurement periods in RRC_INACTIVE and RRC_CONNECTED states.

### 8. REFERENCES

[1] R4-2115367, “WF on Rel-17 positioning enhancements RRM-Part 2”, CATT
[2] R1-2110598, LS on support of SP-SRS for positioning by RRC_INACTIVE UEs, RAN1 LS out
[3] R1-2110644, LS on DL PRS reception priority by RRC_INACTIVE UEs, RAN1 LS out

1-30. (canceled)

31. A method performed by a User Equipment, UE, for performing positioning measurements, the method comprising:
being configured to perform a positioning measurement in a first Radio Resource Control, RRC, state (RRC1);
being triggered to transition from RRC1 to a second RRC state (RRC2), wherein RRC1 comprises an RRC_INACTIVE state and RRC2 comprises an RRC_CONNECTED state;
in response to the trigger, adapting an ongoing positioning measurement procedure based on one or more rules; wherein the one or more rules comprise continuing the ongoing positioning measurement in RRC1 after the transition to RRC2; and
performing the positioning measurement based on the adapted measurement procedure.

32. The method of claim 31 further comprising: informing a network node about the results of the measurement adaptation.

33. The method of claim 31 wherein the one or more rules are pre-defined and/or configured by the network node.

34. The method of claim 31 wherein the one or more rules comprise one or more of:
abandoning or discarding the ongoing positioning measurement in RRC1 after the transition to RRC2;
restarting the ongoing positioning measurement in RRC1 after the transition to RRC2; and
abandoning or discarding the ongoing positioning measurement in RRC1 after the transition to RRC2 and restarting the ongoing positioning measurement in RRC1 after the transition to RRC2.

35. The method of claim 31 further comprising:
continuing the ongoing positioning measurement after the transition to RRC2 if the positioning measurement comprises only a downlink measurement component.

36. The method of claim 31 further comprising:
continuing the ongoing positioning measurement after the transition to RRC2 if the positioning measurement comprises: Reference Signal Time Difference, RSTD, and/or Positioning Reference Signal-Reference Signal Received Power, PRS-RSRP.

37. A method performed by a network node for enabling positioning measurements, the method comprising:
configuring a User Equipment, UE, to perform a positioning measurement in a first Radio Resource Control, RRC, state (RRC1);
triggering the user equipment to transition from RRC1 to a second RRC state (RRC2), wherein RRC1 comprises an RRC_INACTIVE state and RRC2 comprises an RRC_CONNECTED state;
in response to the trigger, the user equipment adapting ongoing positioning measurement procedure based on one or more rules, wherein the one or more rules comprise continuing the ongoing positioning measurement in RRC1 after the transition to RRC2; and
receiving the positioning measurement based on the adapted measurement procedure.

38. The method of claim 37 further comprising: configuring the user equipment with one or more rules.

39. The method of claim 37 further comprising: receiving information about the results of the measurement adaptation.

40. The method of claim 37 wherein the one or more rules comprise one or more of:
abandoning or discarding the ongoing positioning measurement in RRC1 after the transition to RRC2;
restarting the ongoing positioning measurement after the transition to RRC2; and
abandoning or discarding the ongoing positioning measurement in RRC1 after the transition to RRC2 and restarting the ongoing positioning measurement in RRC1 after the transition to RRC2.

41. The method of claim 37 further comprising:
continuing the ongoing positioning measurement after the transition to RRC2 if the positioning measurement comprises only a downlink measurement component.

42. The method of claim 37 further comprising:
continuing the ongoing positioning measurement after the transition to RRC2 if the positioning measurement comprises: Reference Signal Time Difference, RSTD, and/or Positioning Reference Signal-Reference Signal Received Power, PRS-RSRP.

43. A User Equipment, UE, comprising:
at least one processor and memory wherein the memory comprises instructions configured to cause the UE to:
being configured to perform a positioning measurement in a first Radio Resource Control, RRC, state (RRC1);
being triggered to transition from RRC1 to a second RRC state (RRC2), wherein RRC1 comprises an RRC_INACTIVE state and RRC2 comprises an RRC_CONNECTED state; and
in response to the trigger, adapt an ongoing positioning measurement procedure based on one or more rules, wherein the one or more rules comprise continuing the ongoing positioning measurement in RRC1 after the transition to RRC2; and
perform the positioning measurement based on the adapted measurement procedure.

44. A network node comprising:
at least one processor and memory wherein the memory comprises instructions configured to cause the network node to:
configure a user equipment to perform a positioning measurement in a first Radio Resource Control, RRC, state (RRC1);
trigger the user equipment to transition from RRC1 to a second RRC state (RRC2), wherein RRC1 comprises an RRC_INACTIVE state and RRC2 comprises an RRC_CONNECTED state;
in response to the trigger, the user equipment adapts ongoing positioning measurement procedure based on one or more rules, wherein the one or more rules comprise continuing the ongoing positioning measurement in RRC1 after the transition to RRC2; and
receive the positioning measurement based on the adapted measurement procedure.
